(19) United States
(12) Patent Application Publication
(10) Pub. No.: US 2025/0025734 A1
(43) Pub. Date: Jan. 23, 2025

(54) Torsion Detection Flange, Resistance-Adjustable Rotating Wheel and Adjusting Method Therefor, and Sports Device

(71) Applicant: Ningbo Zhuanhe Technology Co., Ltd., Yuyao City, Zhejiang Province (CN)

(72) Inventor: Yuan Pei ZHAO, Yuyao City, Zhejiang Province (CN)

(21) Appl. No.: 18/577,268

(22) PCT Filed: Jul. 12, 2022
(86) PCT No.: PCT/CN2022/105298

§ 371 Date: Jun. 14, 2024

(30) Foreign Application Priority Data
Jul. 12, 2021 (CN) 202110784411.4
Jul. 12, 2021 (CN) 202121578917.1
Jul. 12, 2021 (CN) 202121579024.9

(51) Int. Cl. A63B 21/005; G01L 3/10

(52) U.S. Cl. CPC A63B 21/0052; G01L 3/10

(57) ABSTRACT

Disclosed are a torsion detection flange, a resistance-adjustable rotating wheel and an adjusting method therefor, and a sports device, wherein the resistance-adjustable rotating wheel comprises a fixing device, a resistance adjusting device, a rotating wheel, a metal spacer, and a torque detecting device, wherein the resistance adjusting device is provided with a magnetic surface and is mounted on the fixing device, the rotating wheel is provided with a magnetic conducting surface and is rotatably mounted on the resistance adjusting device in a manner that the magnetic conducting surface is corresponded to the magnetic surface, the metal interlayer is held between the magnetic surface of the resistance adjusting device and the magnetic conducting surface of the rotating wheel, and two ends of the torque detection device are respectively connected to the fixing device and the resistance adjusting device.

### FIELD OF INVENTION

The present invention relates to the field of sport equipment, and in particular relates to a torsion detection flange, a resistance-adjustable rotating wheel and an adjusting method therefor, and a sports device.

### DESCRIPTION OF RELATED ARTS

As people attach importance to physical health, sport device is increasingly favored by consumers, and various kinds of sport device are emerging on the market, especially indoor sport devices, such as treadmills, dynamic bicycles, ellipticals, rowing machines, etc., which are not only popular equipment in gyms, but also favored by a lot of consumers who exercise at home.

Most of the sport device on the market can detect the users exercise data during use, such as exercise speed, exercise power, calorie consumption, exercise time, etc., and promptly feed back to the user interface to facilitate the users real-time view, which in turn allows the user to grasp the exercise condition in real time. Moreover, for judging the product quality of the sport device, the accuracy of the exercise data directly determines the grade of the product quality, in which the amount of error between the actual exercise power and the calibrated exercise power is an important factor for judging the quality grade of the sport device.

To illustrate with an elliptical machine as an example, the elliptical machine comprises a machine body and a resistance adjusting wheel, wherein the machine body comprises a body bracket. a driving wheel mounted on the body bracket, two operating members, a transmission belt, and a control console, and the resistance adjusting wheel comprises a resistance adjusting mechanism, a metal flywheel, a metal ring mounted on the metal flywheel, a position sensor for detecting the position of the resistance adjusting wheel comprises a resistance adjusting mechanism, a metal flywheel, a metal ring mounted on the metal flywheel, a position sensor for detecting the position of the resistance adjusting mechanism, a rotation speed sensor for detecting the rotation speed of the resistance adjusting mechanism and a control module. The resistance adjusting mechanism has a magnetic block, the metal flywheel is rotatably mounted on an outer side of the magnetic block of the resistance adjusting mechanism, and the metal ring is maintained between the metal flywheel and the resistance adjusting mechanism. The distance between the magnetic block and an inner surface of the metal flywheel of the resistance adjusting mechanism is allowed to be adjusted, such that a user can select different resistance level for obtaining different resistance feelings via the elliptical machines control console.

In existing elliptical machines, the different resistance level commands are corresponded to the different predetermined positions of the magnetic block of the resistance adjusting mechanism, and each of the predetermined positions of the magnetic block of the resistance adjusting mechanism corresponding to the corresponding resistance level instruction is a fixed position, i.e. the distance between the magnetic block and the metal flywheel of the resistance adjusting mechanism corresponding to the corresponding resistance level command is a fixed distance. When using the elliptical machine, the user selects a resistance level command, such as “2-speed”, through the display screen of the control console, and the control module of the resistance adjusting mechanism receives the resistance level command, and determines whether or not the position of the magnet block of the resistance adjusting mechanism at this time is the preset position corresponding to “2-speed”, and if not, adjusts the magnet block of the resistance adjusting mechanism to the preset position corresponding to ‘2-speed’.

After selecting the resistance level command, the user drives the operation member, the operation member drives the driving wheel to rotate, the driving wheel drives the metal flywheel to rotate relative to the resistance adjustment mechanism via the transmission belt, and the rotation speed sensor obtains the rotational speed of the metal flywheel.

Before each of the elliptical machines leaves factory, it is pre-set to have a relationship between the resistance levels and the rotation speed and a calibrated power. Specifically, before the elliptical machines leave factory, each of the elliptical machines is tested, then a correspondence between the resistance level and the rotation speed and the calibrated power is obtained, and the correspondence is then applied to all elliptical machines shipped from the factory. In this way, after the user has selected a resistance level command, the resistance adjusting mechanism is adjusted to a preset position corresponding to the resistance level command, the user drives the elliptical machine to rotate, and the elliptical machine obtains a calibrated power at this time based on the resistance level at this time, the rotation speed, and the correspondence between the resistance level and the rotation speed and the calibrated power, and at the same time, the display screen of the control console display shows the calibrated power at this time.

However, due to the fact that there may be differences in the assembly processes of the different elliptical machines before shipment from the factory, or differences between identical parts, various uncertainties lead to inevitable differences among the different elliptical machines. For example, the different elliptical machines may not have the same amount of resistance to the user when the magnet block of the resistance adjusting mechanism is located at the same preset position. Alternatively, the different elliptical machines may have different preset positions corresponding to the same resistance level command. For example, when two elliptical machines are set to “2-speed”, one of the elliptical machines may have a distance of 8 millimeters between the magnet block of the resistance adjusting mechanism and the metal flywheel, and the other elliptical machine may have a distance of 7 millimeters between the magnet block of the resistance adjusting mechanism and the metal flywheel. However, the power displayed by the control console is the same calibrated power when exercising at the same rotation speed and the same the resistance level on the two elliptical machines where differences exist. However, the actual power of the two elliptical machines where differences exist is not the same. That is, there is necessarily a difference between the calibrated power shown on the display of the console of the elliptical machine and the actual power of the user. In other words, the existing power value presented to the user by the elliptical machine is not the actual power value of the user.

In the quality measuring process of the elliptical machine, the smaller the difference between the actual power of the user and the calibrated power, the higher the quality grade of the elliptical machine, and the larger the difference between the actual power of the user and the calibrated power, the lower the quality grade of the elliptical machine. Therefore, how to reduce the difference between the users actual power and the calibrated power has become a difficult problem to be overcome by a number of sport device manufacturers.

### SUMMARY OF THE PRESENT INVENTION

An object of the present invention is to provide a torsion detection flange, a resistance-adjustable rotating wheel, an adjusting method thereof and a sport device, wherein an actual power of a user exercising through the sport device and a calibrated power of the sport device are substantially equivalent.

Another object of the present invention is to provide a torsion detection flange, a resistance-adjustable rotating wheel, an adjustment method thereof and a sport device, wherein a rotating wheel of the resistance-adjustable rotating wheel is rotatably mounted at the resistance adjusting device in such a manner that a magnetic conductive surface is corresponded to a magnetic surface of the resistance adjusting device, and the resistance adjusting device is capable of adjusting the distance between the magnetic conductive surface and the magnetic surface of the rotating wheel, so as to adjust the magnitude of resistance to which the rotating wheel is subjected during rotation.

Another object of the present invention is to provide a torsion detection flange, a resistance-adjustable rotating wheel, an adjusting method thereof and a sport device, wherein the resistance-adjustable rotating wheel utilizes a calibrated power to adjust the distance between the magnetic surface of the resistance adjusting device and the magnetic conductive surface of the rotating wheel to ensure that the actual power of the user and the calibrated power of the sport device are substantially equivalent.

Another object of the present invention is to provide a torsion detection flange, a resistance-adjustable rotating wheel, an adjusting method thereof and a sport device, wherein when a user drives different sport devices at the same speed through the same level control command, the different sport devices adjust the distance the magnetic surface of the resistance adjusting device and the magnetic conductive surface of the rotating wheel based on the difference between the actual power of the user and the calibrated power of the different sport device to ensure that the actual power of the user and the calibrated power of the sport device are substantially equivalent.

Another object of the present invention is to provide a torsion detection flange, a resistance-adjustable rotating wheel, an adjusting method thereof and a sport device, wherein the resistance-adjustable rotating wheel has a torque detecting device, wherein the torque detecting device is used for detecting the magnitude of the torque to which the resistance adjusting device is subjected during the rotation of the rotating wheel with respect to the resistance adjusting device, whereby the actual power of the user can be obtained based on the magnitude of the torque, and further, adjusting a distance between the magnetic surface of the resistance adjusting device and the magnetic conductive surface of the rotating wheel according to a difference between the actual power of the user and the calibrated power of the sport device, in order to correct the actual power of the user, so as to ensure that the actual power of the user and the calibrated power of the sports equipment are substantially equivalent.

Another object of the present invention is to provide a torsion detection flange, a resistance-adjustable rotating wheel, an adjusting method thereof and a sport device, wherein the resistance adjusting device has a larger adjustable range of the distance between the magnetic force surface and the magnetic conductive surface of the rotating wheel, increasing the range of the variation of resistance to which the rotating wheel is subjected during rotation of the rotating wheel. In this way, there is a clear difference among the different levels of resistance to which the rotating wheel is subjected, which not only meets the users needs for different workout intensities, but also increases the fun of the exercise and fitness process, and thus improves the users experience of using the rotating wheel.

Another object of the present invention is to provide a torsion detection flange, a resistance-adjustable rotating wheel, an adjusting method thereof and a sport device, wherein the resistance adjusting device comprises a base plate, a rotating member, a first magnetic tile, and a second magnetic tile, wherein the first magnetic tile and the second magnetic tile are spaced apart from each other and movably retained at two sides of the rotating member, and wherein, during the rotating member is rotating relative to the base plate clockwise or counterclockwise, the rotating member is capable of driving the first magnetic tile and the second magnetic tile closer to or farther away from each other, so as to change the distance between the magnetic surfaces formed by the first magnetic tile and the second magnetic tile and the magnetic conductive surface of the rotating wheel, and thus to change the magnitude of the resistance to which the rotating wheel is subjected during rotation, and to provide a labor-saving and stable adjustment process.

Another object of the present invention is to provide a torsion detection flange, a resistance-adjustable rotating wheel, an adjusting method thereof and a sport device, wherein the resistance adjusting device has a first linkage member and a second linkage member, wherein two ends of the first linkage member are connected at an upper portion of the first magnetic tile and an upper portion of the rotating member, and two ends of the second linkage member are connected at a lower portion of the second magnetic tile and a lower portion of the rotating member, and during rotation of the rotating member relative to the base plate, the first linkage member and the second linkage member change the relative position between the first magnetic tile and the second magnetic tile by synchronously pushing and pulling the first magnetic tile and the second magnetic tile, and thereby change the distance between the magnetic surface and the magnetic conductive surface, which defines an overall simple structure simple and a compact fit.

Another object of the present invention is to provide a torsion detection flange, a resistance-adjustable rotating wheel, an adjusting method thereof and a sport device, wherein the resistance adjusting device can easily drive the first magnetic tile and the second magnetic tile close to each other or away from each other by utilizing the rotating member, the first linkage member and the linkage member, which not only simplifies the overall structure of the resistance adjusting device but also makes the resistance adjusting device more smooth in the actual adjusting process, greatly reduces the failure rate and power consumption of the resistance adjusting device, and, at the same time, brings a better using experience to the user.

Another object of the present invention is to provide a torsion detection flange, a resistance-adjustable rotating wheel, an adjusting method thereof and a sport device, wherein one end of the torsion detection flange is fixed at a fixing device, and another end of the torsion detection flange is fixed at the resistance adjusting device, and wherein the torsion detection flange is not only able to be used for connecting the fixing device to the resistance adjusting device, but also, in the case of the rotating wheel rotates relative to the resistance adjusting device, the torsion detection flange is also capable of detecting the torque applied to the resistance adjusting device, simplifying the structure and assembly process of the resistance-adjustable rotating wheel, and contributing to the reduction of assembly cost.

Another object of the present invention is to provide a torsion detection flange, a resistance-adjustable rotating wheel, an adjusting method thereof and a sport device, wherein the sport device comprises a torque detecting device, wherein the torque detecting device is capable of detecting the torque applied to an internal magnetic control device when the flywheel of the sport device is being driven to make a rotation with respect to the internal magnetic control device, and obtaining the actual power of a user while exercising through the sport device based on the value of the torque.

An object of the present invention is to provide a torsion detection flange, a resistance-adjustable rotating wheel, an adjusting method thereof and a sport device, wherein the sport device is capable of adjusting the swing angle of the swing arm of the inner magnetic control device according to the difference between the actual power of the user when exercising through the exercise device and the calibrated power of the sport device, in order to correct the actual power of the user when exercising through the sport device.

Another object of the present invention is to provide a torsion detection flange, a resistance-adjustable rotating wheel, an adjusting method thereof and a sport device, wherein the sport device comprises a torque detecting device, wherein two opposite ends of the torque detecting device are fixedly mounted at an equipment frame of the sport device and the internal magnetic control device, respectively, so that when the flywheel is driven to rotate relative to the internal magnetic control device, the torque detecting device is capable of detecting a torque to which the internal magnetic control device is subjected.

Another object of the present invention is to provide a torsion detection flange, a resistance-adjustable rotating wheel, an adjusting method thereof and a sport device, wherein the extension direction of the torque detecting device and the extension direction of the internal magnetic control device are perpendicular to each other, so as to avoid the problem of deformation of the internal magnetic control device caused by the equipment frame pushing and pulling the internal magnetic control device through the torque detecting device, to ensure that the internal magnetic control device is always maintained in a natural installation state, which is essential for ensuring the reliability and stability of the internal magnetic control device.

Another object of the present invention is to provide a torsion detection flange, a resistance-adjustable rotating wheel, an adjusting method thereof and a sport device, wherein at least one of the device mounting positions of a mounting end of the torque detecting device and the internal magnetic control device, and the mounting positions of the frame mounting end of the torque detecting device and the equipment frame is adjustable, such that when the torque detecting device is installed between the equipment frame and the internal magnetic control device, the problem of deformation of the internal magnetic control device caused by the equipment frame pushing and pulling the internal magnetic control device through the torque detecting device can be avoided.

According to an aspect of the present invention, the present invention further provides a resistance-adjustable rotating wheel, which comprises:
a fixing device;
a resistance adjusting device, wherein the resistance adjusting device has a magnetic surface and the resistance adjusting device is mounted to the fixing device;
a rotating wheel, wherein the rotating wheel has a magnetic conductive surface, wherein the rotating wheel is rotatably mounted at the resistance adjusting device in such a manner that the magnetic conductive surface is corresponded to the magnetic surface;
a metal spacer, wherein the metal spacer is held between the magnetic surface of the resistance adjusting device and the magnetic conductive surface of the rotating wheel; and
a torque detecting device, wherein two ends of the torque detecting device are connected with the fixing device and the resistance adjusting device, respectively.

According to another aspect of the present invention, the present invention further provides a sport device, which comprises:
an equipment frame;
a flywheel rotatably installed at the equipment frame;
an internal magnetic control device, wherein the internal magnetic control device is mounted at the equipment frame, and an outer side of the internal magnetic control device is surrounded by the flywheel; and
a torque detecting device, wherein the torque detecting device has a device mounting end and a frame mounting end corresponding to the device mounting end, wherein the device mounting end and the frame mounting end of the torque detecting device are mounted at the internal magnetic control device and the equipment frame, respectively, and wherein an extension direction of the torque detecting device and an extension direction of the internal magnetic control device are perpendicular to each other.

### BRIEF DESCRIPTION OF THE DRAWINGS

FIG. 1A is a perspective schematic diagram of a sport device according to a preferred embodiment of the present invention.

FIG. 1B is an exploded schematic diagram of the sport device according to the above preferred embodiment of the present invention.

FIG. 2 is a perspective schematic diagram of a resistance-adjustable rotating wheel according to the above preferred embodiment of the present invention.

FIG. 3 is an exploded schematic diagram of the resistance-adjustable rotating wheel according to the above preferred embodiment of the present invention.

FIG. 4A is a usage schematic diagram of a resistance-adjustable rotating wheel according to another preferred embodiment of the present invention.

FIG. 4B is a usage schematic diagram of a resistance-adjustable rotating wheel according to another preferred embodiment of the present invention.

FIG. 5A is a usage scenario schematic diagram of a resistance-adjustable rotating wheel according to another preferred embodiment of the present invention.

FIG. 5B is a usage scenario schematic diagram of the resistance-adjustable rotating wheel according to the above preferred embodiment of the present invention.

FIG. 5C is a usage scenario schematic diagram of the resistance-adjustable rotating wheel according to the above preferred embodiment of the present invention.

FIG. 5D is a usage scenario schematic diagram of the resistance-adjustable rotating wheel according to the above preferred embodiment of the present invention.

FIG. 5E is a usage scenario schematic diagram of the resistance-adjustable rotating wheel according to the above preferred embodiment of the present invention.

FIG. 5F is a usage scenario schematic diagram of the resistance-adjustable rotating wheel according to the above preferred embodiment of the present invention.

FIG. 5G is a usage scenario schematic diagram of the resistance-adjustable rotating wheel according to the above preferred embodiment of the present invention.

FIG. 5H is a usage scenario schematic diagram of the resistance-adjustable rotating wheel according to the above preferred embodiment of the present invention.

FIG. 5I is a usage scenario schematic diagram of the resistance-adjustable rotating wheel according to the above preferred embodiment of the present invention.

FIG. 6 is a flow diagram of an adjusting method the resistance-adjustable rotating wheel according to the above preferred embodiment of the present invention.

FIG. 7 is a perspective schematic diagram of a resistance-adjustable rotating wheel according to a preferred embodiment of the present invention.

FIG. 8 is an exploded schematic diagram of the resistance-adjustable rotating wheel according to the above preferred embodiment of the present invention.

FIG. 9A is a sectional schematic diagram of a partial structure of the resistance-adjustable rotating wheel according to the above preferred embodiment of the present invention.

FIG. 9B is a sectional schematic diagram of a partial structure of a resistance-adjustable rotating wheel according to another preferred embodiment of the present invention.

FIG. 9C is a sectional schematic diagram of a partial structure of a resistance-adjustable rotating wheel according to another preferred embodiment of the present invention.

FIG. 10A is a usage scenario schematic diagram of a resistance-adjustable rotating wheel according to another preferred embodiment of the present invention.

FIG. 10B is a usage scenario schematic diagram of the resistance-adjustable rotating wheel according to the above preferred embodiment of the present invention.

FIG. 10C is a usage scenario schematic diagram of the resistance-adjustable rotating wheel according to the above preferred embodiment of the present invention.

FIG. 10D is a usage scenario schematic diagram of the resistance-adjustable rotating wheel according to the above preferred embodiment of the present invention.

FIG. 10E is a usage scenario schematic diagram of the resistance-adjustable rotating wheel according to the above preferred embodiment of the present invention.

FIG. 10F is a usage scenario schematic diagram of the resistance-adjustable rotating wheel according to the above preferred embodiment of the present invention.

FIG. 10G is a usage scenario schematic diagram of the resistance-adjustable rotating wheel according to the above preferred embodiment of the present invention.

FIG. 10H is a usage scenario schematic diagram of the resistance-adjustable rotating wheel according to the above preferred embodiment of the present invention.

FIG. 10I is a usage scenario schematic diagram of the resistance-adjustable rotating wheel according to the above preferred embodiment of the present invention.

FIG. 11 is a perspective schematic diagram of a sport device according to a preferred embodiment of the present invention.

FIG. 12 is a perspective schematic diagram of a partial structure of the sport device according to the above preferred embodiment of the present invention.

FIG. 13 is an enlarged schematic diagram of the partial structure of the sport device shown in FIG. 12.

FIG. 14A is an exploded schematic diagram of the partial structure of the sport device according to the above preferred embodiment of the present invention, according to an angle of view.

FIG. 14B is an exploded schematic diagram of the partial structure of the sport device according to the above preferred embodiment of the present invention, according to another angle of view.

FIG. 15A is an exploded schematic diagram of an internal magnetic control device of the sport device according to the above preferred embodiment of the present invention, according to an angle of view.

FIG. 15B is an exploded schematic diagram of the internal magnetic control device of the sport device according to the above preferred embodiment of the present invention, according to another angle of view.

FIG. 16 is a perspective schematic diagram of a partial structure of an alternative of the sport device according to the above preferred embodiment of the present invention.

### DETAILED DESCRIPTION OF THE EMBODIMENTS

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal”, “lateral”, “upper”, “lower”, “front”, “back”, “left”, “right”, “perpendicular”, “horizontal”, “top”, “bottom”, “inner”, “outer” and etc. just indicate relations of direction or position are based on the relations of direction or position shown in the appended drawings, which is only to facilitate descriptions of the present invention and to simplify the descriptions, rather than to indicate or imply that the referred device or element must apply specific direction or to be operated or configured in specific direction. Therefore, the above-mentioned terminologies shall not be interpreted as confine to the present invention.

It will be understood that the term “a” should be understood as “at least one” or “one or more”, that is, in one embodiment, the number of an element may be one, and in other embodiments, the number of the element can be greater than one, and the term “a” cannot be construed as a limitation to the quantity.

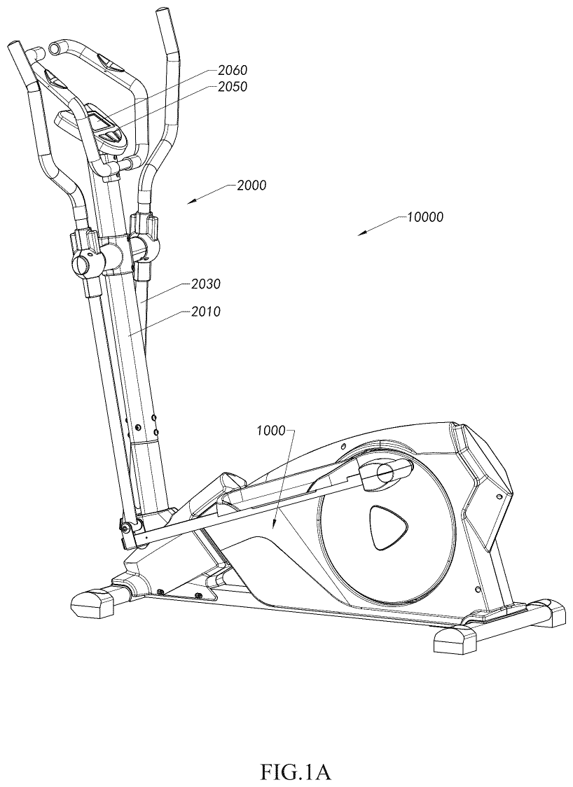

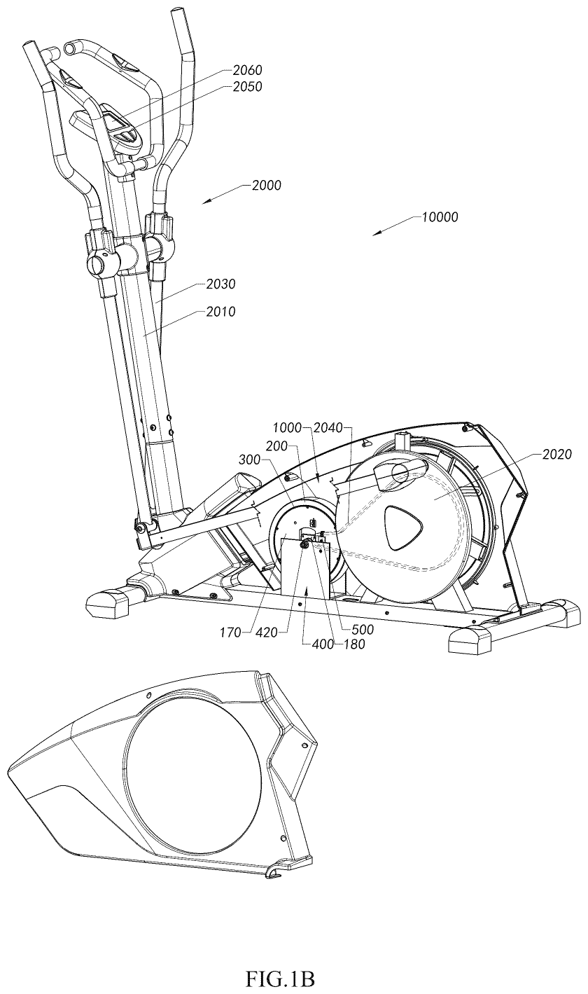

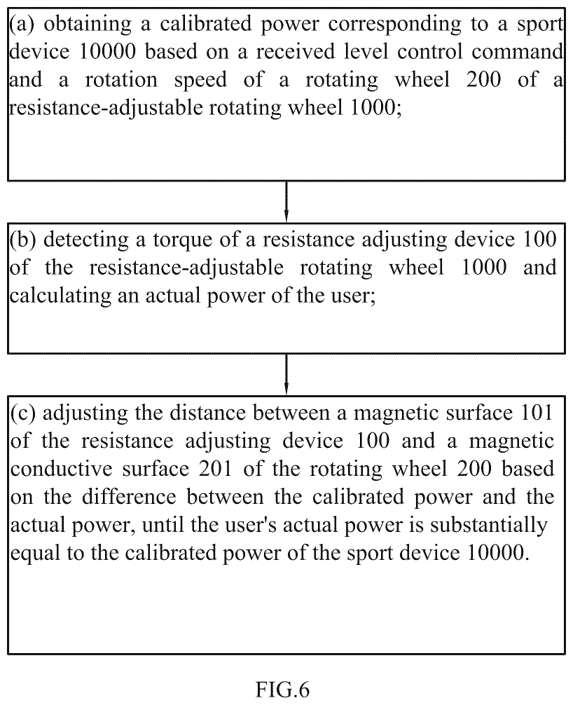

Referring to FIGS. 1A to 6 of the accompanying drawings, a sport device 10000 according to a preferred embodiment of the present invention will be described in the ensuing description, wherein an actual power of a user when exercising through the sport device 10000 and a calibrated power of the sport device 10000 are substantially equivalent, significantly improving the quality grade of the sport device 10000.

Specifically, the sport device 10000 comprises a resistance-adjustable rotating wheel 1000 and an equipment body 2000, wherein the resistance-adjustable rotating wheel 100 comprises a resistance-adjusting device 100, a rotating wheel 200, a metal spacer 300, a fixing device 400, and a torque detecting device 500. The rotating wheel 200 is rotatably mounted at the resistance adjusting device 100, the metal spacer 300 is held between the resistance adjusting device 100 and the rotating wheel 200. The resistance detecting device 500 is mounted at the fixing device 400, one end of the torque detecting device 500 is connected with the resistance adjusting device 100 and another end of the torque detecting device 500 is the fixing device 400. The rotating wheel 200 of the resistance-adjustable rotating wheel 1000 is drivably connected to the equipment body 2000, the torque detecting device 500 is used to detect in real time the amount of torque to which the resistance adjusting device 100 is subjected during the rotation of the rotating wheel 200 with respect to the resistance adjusting device 100, in order to calculate, subsequently, the actual power of the user in the operation of the equipment body 2000, based on the amount of torque to which the resistance adjusting device 100 is subjected.

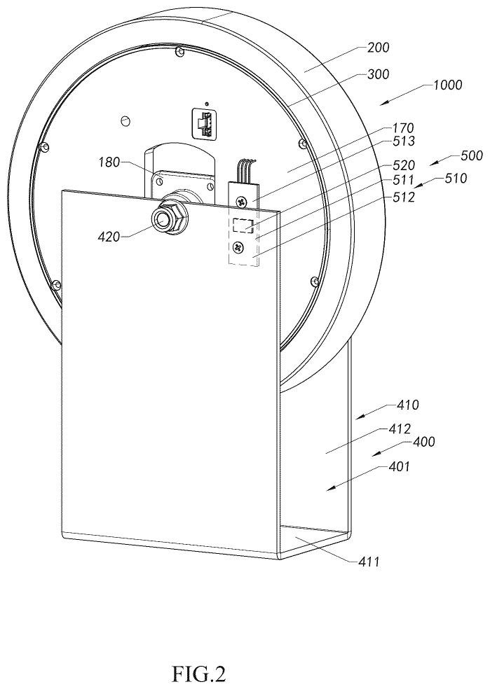

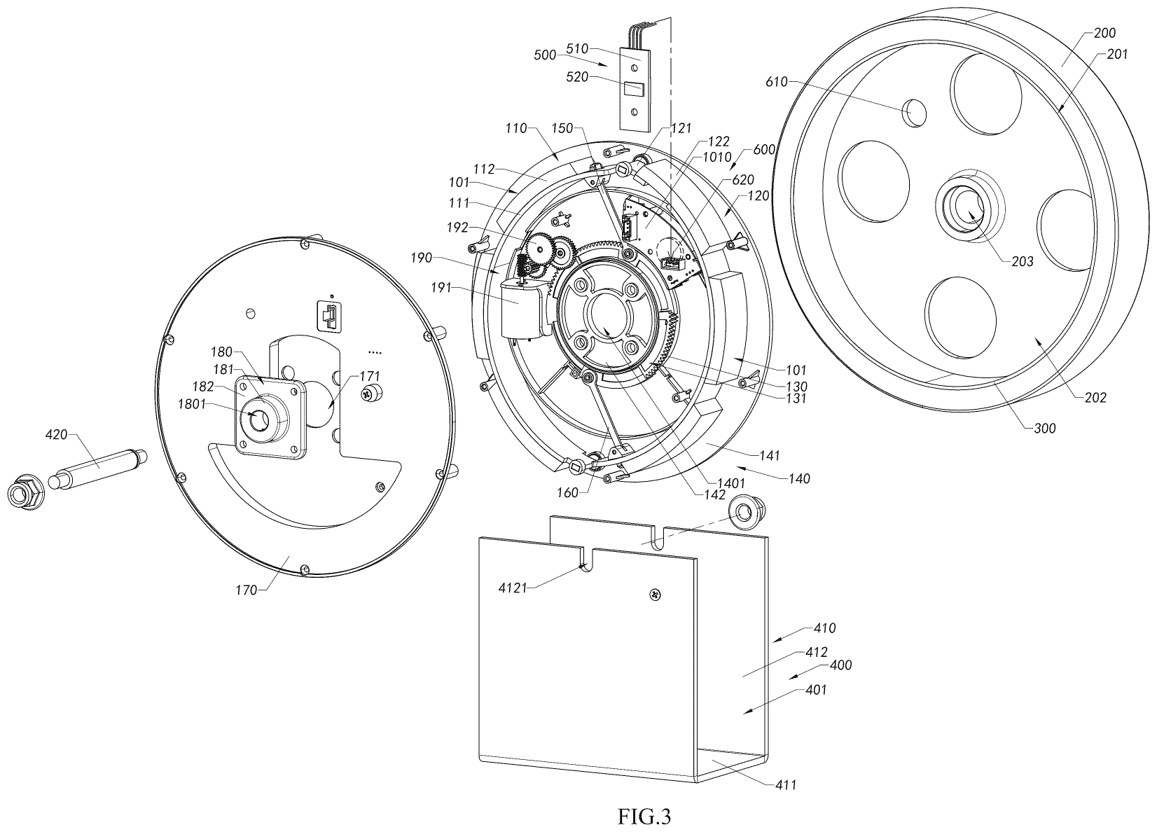

Referring to FIGS. 2 and 3, in this particular embodiment of the present invention, the resistance adjusting device 100 has a magnetic surface 101 and the rotating wheel 200 has a magnetic conductive surface 201 and a receiving space 202. The rotating wheel 200 is held at an outer side of the resistance adjusting device 100 in such a way that the magnetic conductive surface 201 is corresponded to the magnetic surface 101 of the resistance adjusting device 100, the resistance adjusting device 100 is held within the receiving space 202 of the rotating wheel 200. Moreover, the rotating wheel 200 is capable of being driven to rotate relative to the resistance adjusting device 100. For example, but not limited to, the user can drive the rotating wheel 200 to rotate relative to the resistance adjusting device 100 by foot pedal, stomp, foot tread, hand crank, etc., and the user exercises and works out while driving the rotating wheel 200 to rotate relative to the resistance adjusting device 100. The metal spacer 300 is held between the magnetic surface 101 of the resistance adjusting device 100 and the magnetic conductive surface 201 of the rotating wheel 200.

Further, the resistance adjusting device 100 is operatively held at a side of the rotating wheel 200, and the resistance adjusting device 100 is capable of adjusting the amount of resistance to which the rotating wheel 200 is subjected by adjusting the distance between the magnetic surface 101 and the magnetic conductive surface 201 of the rotating wheel 200. In this way, the user is allowed to select different levels of resistance in order to achieve suitable workout intensity.

Referring to FIG. 3, the equipment body 2000 comprises a supporting frame 2010, a transmission wheel 2020, two driving members 2030, and a transmission belt 2040, wherein the transmission wheel 2020 is rotatably mounted at the supporting frame 2010, the driving members 2030 are operatively mounted at two side of the transmission wheel 2020, and the transmission wheel 2020 is connected with the rotating wheel 200 of the resistance-adjustable rotating wheel 1000 through the transmission belt 2040. During the driving member 2030 drives the transmission wheel 2020 to rotate relative to the supporting frame 2010, the transmission wheel 2020 drives the transmission belt 2040 and the rotating wheel 200 of the resistance-adjustable rotating wheel 1000 to rotate. The rotating wheel 200 rotates relative to the resistance adjusting device 100, and by changing the distance between the magnetic surface 101 of the resistance adjusting device 100 and the magnetic conductive surface 201 of the rotating wheel 200 to change the amount of resistance to which the rotating wheel 200 is subjected, and thus to adjust the amount of resistance to which the equipment body 2000 is subjected, so as to adjust the amount of resistance felt by a user when utilizing the equipment body 2000 to regulate the amount of resistance felt by the user while exercising.

It is worth mentioning that the specific implementation of the driving member 2030 is not limited, and the driving member 2030 is allowed to be driven by a foot pedal, a foot stirrup, a foot pedal, a hand crank, a hand push, a hand pull, and so on. And, the specific implementation of the equipment body 2000 is not limited, and the equipment body 2000 may be implemented as an elliptical machine, a kinetic bicycle, a rowing machine, or a sport device known to those skilled in the art. Moreover, it should be understood by those skilled in the art that the specific embodiments of the equipment body 2000 disclosed in the specification and the accompanying drawings are intended as examples only and are not to be a limitation on the content and scope of the sport device 10000 described herein.

Referring to FIGS. 1A and 1B, the equipment body 2000 comprises a control console 2050 and a display 2060, wherein the display 2060 is communicatively connected with the control console 2050, and the control console 2050 is communicatively connected with the resistance adjusting device 100 of the resistance-adjustable rotating wheel 1000. The control console 2050 is capable of processing data obtained by the resistance adjusting device 100 to obtain an exercise data of a user during an exercise session, wherein the exercise data is for example, but not limited to, exercise speed, exercise power, calories burned, exercise time, etc. The display 2060 displays the exercise data generated by the control console 2050 to facilitate the user to keep track of the exercise condition in real time.

Further, the display 2060 allows selection or input of a level control command, the control console 2050 can send the level control command to the control unit 1010 of the resistance adjusting device 100, the control unit 1010 controls the operating state of the resistance adjusting device 100 based on the actual power of the user and the calibrated power of the sport device 10000, to adjust the distance between the magnetic surface 101 and the magnetic conductive surface 201 of the rotating wheel 200, and to ensure the actual power of the user and the calibrated power of the sport device 10000 to be consistent with each other.

Referring to FIG. 3, in this specific embodiment of the resistance-adjustable rotating wheel 1000 as described herein, the resistance adjusting device 100 comprises a first magnetic tile 110, a second magnetic tile 120, a rotating member 130, and a base plate 140, wherein each of the first magnetic tile 110 and the second magnetic tile 120 has a magnetic surface 101. The rotating member 130 is rotatably mounted at the base plate 140, and the first magnetic tile 110 and the second magnetic tile 120 are movably held at two sides of the rotating member 130.

The rotating wheel 200 is implemented to be made of metal, i.e., the magnetic conductive surface 101 of the rotating wheel 200 is metallic, and the rotating wheel 200 is rotatably held at an outside of the first magnetic tile 110 and the second magnetic tile 120 in such a manner that the magnetic conductive surface 201 is corresponded to the magnetic surfaces 101 of the first magnetic tile 110 and the second magnetic tile 120. The metal spacer 300 is held between the magnetic conductive surface 101 of the rotating wheel 200 and the magnetic surfaces 101 of the resistance adjusting device 100 in a manner that is mounted to the magnetic conductive surface 101 of the rotating wheel 200. During the process of the rotating member 130 of the resistance adjusting device 100 rotates relative to the base plate 140, the rotating member 130 drives the first magnetic tile 110 and the second magnetic tile 120 to move relative to each other and make the first magnetic tile 110 and the second magnetic tile 120 to move closer to each other or farther away from each other, thereby adjusting the resistance to which the rotating wheel 200 is subjected during rotation.

More specifically, the first magnetic tile 110 and the second magnetic tile 120 are spacedly held at two sides of the rotating member 130, and when the first magnetic tile 110 and the second magnetic tile 120 move close to each other, the magnetic surface 101 of the first magnetic tile 110 and the magnetic surface 101 of the second magnetic tile 120 get closer to each other, and at the same time, the magnetic surface 101 of the first magnetic tile 110 and the magnetic surface 101 of the second magnetic tile 120 move in a direction away from the magnetic conductive surface 201 of the rotating wheel 200. At this point, the resistance the rotating wheel 200 is subjected to is reduced, as the rotating wheel 200 rotates relative to the resistance adjusting device 100.

When the first magnetic tile 110 and the second magnetic tile 120 move away each other, the magnetic surface 101 of the first magnetic tile 110 and the magnetic surface 101 of the second magnetic tile 120 move away from each other, and at the same time, the magnetic surface 101 of the first magnetic tile 110 and the magnetic surface 101 of the second magnetic tile 120 move in a direction away from the magnetic conductive surface 201 of the rotating wheel 200. At this point, the resistance the rotating wheel 200 is subjected to is increased, as the rotating wheel 200 rotates relative to the resistance adjusting device 100.

Referring to FIG. 3, in this specific embodiment of the present invention, the resistance adjusting device 100 further comprises a first linkage member 150 and a second linkage member 160, wherein two ends of the first linkage member 150 are rotatably connected with an upper portion of the rotating member 130 and an upper portion of the first magnetic tile 110, respectively, and two ends of the second linkage member 160 are rotatably connected with a lower portion of the rotating member 130 and a lower portion of the second magnetic tile 120, respectively. A lower portion of the first tile 110 is rotatably mounted at a lower portion of the base plate 140 and an upper portion of the second tile 120 is rotatably mounted at an upper portion of the base plate 140. During process of the rotating member 130 rotates relative to the base plate 140, the rotating member 130 drives the first linkage member 150 and the second linkage member 160 to move, and the first linkage member 150 and the second linkage member 160 drive the first magnetic tile 110 and the second magnetic tile 120 to move, respectively, such that the first tile 110 and the second tile 120 can move closer to each other or further away from each other.

For example, when the rotating member 130 is driven to rotate clockwise with respect to the base plate 140, the rotating member 130 drives the first linkage member 150 to move from left to right, while the rotating member 130 drives the second linkage member 160 to move from right to left. The first linkage member 150 pulls the first magnetic tile 110, the lower portion of the first magnetic tile 110 rotates clockwise relative to the base plate 140, the upper portion of the first magnetic tile 110 gets closer to the rotating member 130 and the upper portion of the second magnetic tile 120, and the magnetic surface 101 of the first magnetic tile 110 moves in a direction away from the magnetic conducting surface 201 of the rotating wheel 200. The second linkage member 160 pulls the second magnetic tile 120, the upper portion of the second magnetic tile 120 rotates clockwise relative to the base plate 140, the second magnetic tile 120 moves closer to the rotating member 130 and the lower portion of the first magnetic tile 110, and the magnetic surface 101 of the second magnetic tile 120 moves in a direction away from the magnetic conductive surface 201 of the rotating wheel 200. During the process, the distance between the magnetic surface 101 of the resistance adjusting device 100 and the magnetic conductive surface 201 of the rotating wheel 200 is gradually increased, and the resistance subjected to by the rotating wheel 200 is gradually decreased as the rotating wheel 200 is driven to rotate.

Further, when the rotating member 130 is driven to rotate counterclockwise with respect to the base plate 140, the rotating member 130 drives the first linkage member 150 to move from right to left, while the rotating member 130 drives the second linkage member 160 to move from left to right. The first linkage member 150 pushes the first magnetic tile 110, the lower portion of the first magnetic tile 110 rotates counterclockwise relative to the base plate 140, the upper portion of the first magnetic tile 110 gets further away from the rotating member 130 and the upper portion of the second magnetic tile 120, and the magnetic surface 101 of the first magnetic tile 110 moves in a direction closer to the magnetic conducting surface 201 of the rotating wheel 200. The second linkage member 160 pushes the second magnetic tile 120, the upper portion of the second magnetic tile 120 rotates counterclockwise relative to the base plate 140, the second magnetic tile 120 moves further away from the rotating member 130 and the lower portion of the first magnetic tile 110, and the magnetic surface 101 of the second magnetic tile 120 moves in a direction closer to the magnetic conductive surface 201 of the rotating wheel 200. During the process, the distance between the magnetic surface 101 of the resistance adjusting device 100 and the magnetic conductive surface 201 of the rotating wheel 200 is gradually decreased, and the resistance subjected to by the rotating wheel 200 is gradually increased as the rotating wheel 200 is driven to rotate relative to the resistance adjusting device 100.

That is to say, the resistance adjusting device 100 described in the present invention can easily drive the first magnetic tile 110 and the second magnetic tile 120 closer to or farther away from each other by utilizing the rotating member 130, the first linkage member 15 and the second linkage member 160, which has a simple structure and a compact fit. The resistance adjusting device 100 not only simplifies the overall structure of the resistance adjusting device but also makes the resistance adjusting device smoother in the actual adjusting process, greatly reduces the failure rate and power consumption of the resistance adjusting device 100, and, at the same time, brings a better using experience to the user.

It is worth mentioning that driving the first magnetic tile 110 and the second magnetic tile 120 closer to each other and farther away from each other by driving the rotating member 130 of the resistance adjusting device 100 to rotate clockwise and counterclockwise can enlarge the range of motion of the first magnetic tile 110 and the second magnetic tile 120. In this way, the resistance to which the rotating wheel 200 is subjected during its rotation with respect to the resistance adjusting device 100 is allowed to be adjusted in a larger range, and there can be a clear difference between two different levels of resistance, which is conducive to satisfying the users need for different exercise intensities and further improving the users experience.

In a specific embodiment of the present invention, the first linkage member 150 is maintained to be inclinedly connected with the first magnetic tile 110 and the rotating member 130. The second linkage member 160 is maintained to be inclinedly connected with the second magnetic tile 120 and the rotating member 130. Preferably, an angle of inclination between the first linkage member 150 and the first magnetic tile 110 is always greater than or equal to 90°. An angle of inclination between the second linkage member 160 and the second magnetic tile 120 is always greater than or equal to 90°. In this way, the rotating member 130 can easily drive the first linkage member 150, the second linkage member 160, the first magnetic tile 110 and the second magnetic tile 120 to move, so as to enable the resistance adjusting device 100 to smoothly adjust the amount of resistance to which the rotating wheel 200 is subjected during rotation.

Preferably, the first linkage member 150 and the second linkage member 160 have the same length, the first linkage member 150 and the second linkage member 160 are maintained parallel to each other and provided above and below the rotating member 130, respectively, and a connection position between the first linkage member 150 and the rotating member 130, a center of the rotating member 130, a connection position between the second linkage member 150 and the rotating member 130 are located at the same straight line, and the distance and range of synchronized movement of the first magnetic tile 110 and the second magnetic tile 120 are maintained to be consistent with each other.

Alternatively, the first linkage member 150 and the second linkage member 160 are not of the same length, and the first linkage member 150 and the second linkage member 160 are not inclined at the same angle. It should be understood by those skilled in the art that the specific implements of the first linkage member 150 and the second linkage member 160 are merely exemplary and cannot be a limitation to the content and scope of the resistance adjusting device 100 of the present invention.

In this specific embodiment of the present invention, the first magnetic tile 110 comprises a first load-bearing element 111 and at least one first magnetic block 112, wherein the magnetic surface 101 of the first magnetic tile 110 is formed on an outer surface of the first magnetic block 112. The first magnetic block 112 is mounted at the first load-bearing element 111 in such a way that the magnetic surface 101 faces outward. For example, but not limited to, the first magnetic block 112 is fixed at the first load-bearing element 111 by gluing, embedding, or other means known to those skilled in the art.

The second magnetic tile 120 comprises a second load-bearing element 121 and at least one second magnetic block 122, wherein the magnetic surface 101 of the second magnetic tile 120 is formed on an outer surface of the second magnetic block 122. The second magnetic block 122 is mounted at the second load-bearing element 121 in such a way that the magnetic surface 101 faces outward. For example, but not limited to, the second magnetic block 112 is fixed at the second load-bearing element 121 by gluing, embedding, or other means known to those skilled in the art.

Specifically, the magnetic conductive surface 201 of the rotating wheel 200 and the magnetic surfaces 101 of the magnetic blocks of the resistance adjusting device 100 define an external magnetic field therebetween, wherein when the rotating wheel 200 is driven to rotate with respect to the resistance adjusting device 100, the metal spacer 300 moves following the rotating wheel 200, and when the metal spacer 300 passes by a left edge of the magnetic blocks of the resistance adjusting device 100, a magnetic field experienced by the metal spacer 300 has a greater magnetic field strength and a counterclockwise eddy current is generated, and the eddy current generates an internal magnetic field, the direction of the internal magnetic field is opposite to the direction of the external magnetic field, which in turn generates a magnetic resistance. When the magnetic surfaces 101 of the magnetic blocks of the resistance adjusting device 100 is close to the magnetic conductive surface 201 of the rotating wheel 200, the magnetic resistance is increased and the rotating wheel 200 is subjected to increased resistance during rotation. When the magnetic surfaces 101 of the magnetic blocks is away from the magnetic conductive surface 201 of the rotating wheel 200, the magnetic resistance is decreased and the rotating wheel 200 is subjected to less resistance while rotating.

Preferably, the first magnetic tile 110 comprises a plurality of the first magnetic blocks 112 having the same size, the second magnetic tile 120 comprises a plurality of the second magnetic blocks 122 having the same size, wherein the plurality of the first magnetic blocks 112 are spacedly and evenly arranged on the first load-bearing element 111, the plurality of the second magnetic blocks 122 are spacedly and evenly arranged on the second load-bearing element 121. The plurality of the first magnetic blocks 112 and the plurality of the second magnetic blocks 122 surround an outer side of the rotating member 130 in such a manner that the magnetic surfaces 101 face outward. Optionally, the plurality of the first magnetic blocks 112 is not uniform in size. Optionally, the plurality of the second magnetic blocks 122 is not uniform in size. Optionally, the intervals of the first magnetic blocks 112 are inconsistent. Optionally, the intervals of the second magnetic blocks 122 are inconsistent.

It is worth mentioning that the specific implements of the first magnetic tile 110 and the second magnetic tile 120 illustrated in the specification and the accompanying drawings are intended as examples only, and cannot be a limitation to the content and scope of the resistance adjusting device 100 described in the present invention.

In this specific embodiment of the resistance-adjustable rotating wheel 1000 of the present invention, the base plate 140 of the resistance-adjusting device 100 comprises a carrying platform 141 and a cylindrical assembling convex plate 142 extended outwardly from the carrying platform 141, wherein the rotating member 130 has a circular assembling opening 131, the rotating member 130 is mounted at the carrying platform 141 in such a manner that the assembling opening 131 is corresponded to the assembling convex plate 142. The assembling convex plate 142 of the base plate 140 is held in the assembling opening 131 of the rotating member 130, wherein an inner surface of the assembling opening 131 defined by the rotating member 130 is attached with an outer surface of the assembling convex plate 142 to facilitate the rotating member 130 maintaining a smooth rotation.

The fixing device 400 further comprises a fixing base 410 and an assembling shaft 420, wherein the fixing base 410 comprises a fixed portion 411 and two support portions 412 spaced from each other, wherein each of the support portions 412 has an assembling hole 4121, and wherein the two support portions 412 are extended upwardly from two sides of the fixed portion 411, and the fixed portion 411 and the two support portions 412 form a rotation space 401 therebetween, wherein the assembling holes 4121 of the support portions 412 are communicated with the rotation space 401. Two ends of the assembling shaft 420 are secured in the support portions 412, respectively.

The base plate 140 of the resistance adjusting device 100 of the resistance-adjustable rotating wheel 1000 further has an assembling channel 1401, wherein the assembling channel 1401 runs through the assembling convex plate 142 and the carrying platform 141, wherein the rotating wheel 200 further has a mounting hole 203, wherein the rotating wheel 200 is held at a side of the resistance adjusting device 100 in a manner that the mounting hole 203 is corresponded to the assembling channel 1401 of the base plate 140. The assembling shaft 420 is mounted in the assembling channel 1401 of the base plate 140 and the mounting hole 203 of the rotating wheel 200. During use, the fixing portion 411 of the fixing base 410 is secured to the ground, and the rotating wheel 200 is capable of being driven to move with respect to the resistance adjusting device 100, the fixing base 410, and the assembling shaft 420.

The resistance adjusting device 100 further comprises an outer cover 170, wherein the outer cover 170 has a through hole 171, wherein the outer cover 170 is held at a side of the resistance adjusting device 100 in such a manner that the through hole 171 is corresponded to the assembling shaft 420 and shelters an opening of the receiving space 202 of the rotating wheel 200, so that the resistance adjusting device 100 can be concealed within the receiving space 202 of the rotating wheel 200, which not only reduces contamination of the resistance adjusting device 100 and the interior of the rotating wheel 200, but also contributes to increasing the safety of use of the resistance-adjustable rotating wheel 1000.

The resistance-adjustable rotating wheel 1000 further comprises a flange 180, wherein the flange 180 comprises a locking portion 181 and an assembling portion 182, wherein the locking portion 181 has a locking channel 1801, and the assembling portion 182 is extended outwardly from an edge of the locking portion 181. The locking portion 181 of the flange 180 is mounted to the assembling shaft 420 in such a manner that the locking channel 1801 is corresponded to the assembling shaft 420, for example, but not limited to, the locking portion 181 is mounted at the assembling shaft 420 by a threaded connection. The assembling portion 182 of the flange 180 is mounted at the outer cover 170, for example, but not limited to, the assembling portion 182 is mounted at the outer cover 170 by means of a screw, a bolt, a screw, a bolt, and a bolt.

In this specific implement of the resistance adjusting device 100 of the present invention, the resistance adjusting device 100 further comprises a driving assembly 190, wherein the driving assembly 190 comprises a driving motor 191 and a transmission gear set 192, wherein the driving motor 191 and the transmission gear set 192 are mounted at the base plate 140, wherein the driving motor 191 and the transmission gear set 192 are located at a side of the rotating member 130, and the transmission gear set 192 is located between the driving motor 191 and the rotating member 130. The rotating member 130 has a plurality of gear teeth matching the gear teeth of the transmission gear set 192, and the driving motor 191 is capable of driving the transmission gear set 192 to rotate to drive the rotating member 130 to rotate clockwise or counterclockwise with respect to the base plate 140, and thereby drive the first magnetic tile 110 and the second magnetic tile 120 close to each other or away from each other by the first linkage member 150 and the second linkage member 160, thereby adjust the amount of resistance to which the rotating wheel 200 is subjected during rotation.

Referring to FIG. 3, the resistance-adjustable rotating wheel 1000 further comprises a rotation speed detecting assembly 600, wherein the rotation speed detecting assembly 600 comprises a sensing member 610 and a rotation speed sensor 620, wherein the sensing member 610 is disposed at the rotating wheel 200 and the rotation speed sensor 620 is disposed at the resistance adjusting device 100. The rotating wheel 200 is mounted at the resistance adjusting device 100 in such a manner that the sensing member 610 can face the speed sensor 620. During process of the rotating wheel 200 rotates with respect to the resistance adjusting device 100, the sensing member 610 rotates with respect to the rotation speed sensor 620, and when the sensing member 610 faces the rotation speed sensor 620, the rotation speed sensor 620 is capable of sensing the sensing member 610 and outputting a pulse signal corresponding to the rotational frequency of the sensing member 610, whereby the rotation speed of the sensing member 610 can be obtained to indirectly obtain the rotation speed of the rotating wheel 200.

For example, but not limited to, the rotation speed sensor 620 is implemented as a Hall sensor. Optionally, the rotation speed sensor 620 is mounted on the base plate 140. The specific mounting position of the rotation speed sensor 620 is merely exemplary and must not be a limitation on the content and scope of the resistance adjustment device 100 of the present invention.

The sensing member 610 is implemented as a magnetic material or a magnetic conductive material, for example, but not limited to, the sensing member 610 is implemented as a magnet. Preferably, the sensing member 610 is provided in the rotating wheel 200 in such a way that it protrudes from an inner surface of the rotating wheel 320.

That is to say, the rotation speed detecting assembly 600 is integrated inside the resistance adjusting device 100 and the rotating wheel 200, which simplifies the installation process of the rotation speed detecting assembly 600 and avoids the installation deviation of the rotation speed detecting assembly 600 during the cumbersome installation process from affecting the accuracy of the detection results. In other words, the rotation speed detecting assembly 600 of the present invention has a high detection accuracy, which, in this way, facilitates the improvement of the accuracy of the calculation results based on the rotation speed detected by the rotation speed detecting assembly 600.

The resistance adjusting device 100 further comprises a control module 1010, wherein the control module 1010 is communicatively coupled to the torque detecting device 500 and the rotation speed sensor 620 of the rotation speed detecting assembly 600, wherein the control module 1010 can calculate the actual power of the user based on the torque detected by the torque detecting device 500 and the rotation speed detected by the rotation speed sensor 620. Preferably, the rotation speed sensor 620 is mounted to the control module 1010. Preferably, the rotation speed sensor 620 is mounted at the control module 1010.

The control module 101 is communicatively coupled to the equipment body 2000, the control module 1010 is capable of obtaining a level control command from the equipment body 2000, the control module 1010 can obtain a calibrated power of the sport device 10000 based on the level control command and the rotation speed detected by the rotation speed sensor 620. The correspondence between the level control command, the rotation speed, and the calibrated power of the sport device 10000 can be pre-set before it leaves factory.

Further, the control module 101 is communicatively coupled to the driving motor 191 of the driving assembly 190, and the control module 1010 controls the working state of the driving motor 191 based on the difference between the calibrated power of the sport device 10000 and the actual power of the user, for example, but not limited to rotating speed, rotation direction and rotation angle of the driving motor 191, thereby driving the first magnetic tile 110 and the second magnetic tile 120 closer to each other or farther away from each other to change the magnitude of the torque applied to the torque regulating device 100 until the actual power of the user obtained based on the magnitude of the torque applied to the torque regulating device 100 and the calibrated power of the sport device 10000 are consistent.

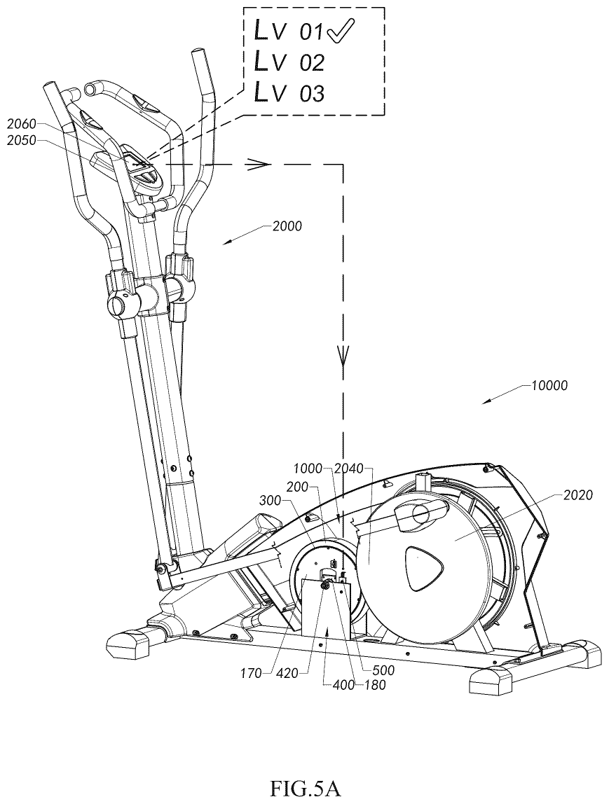

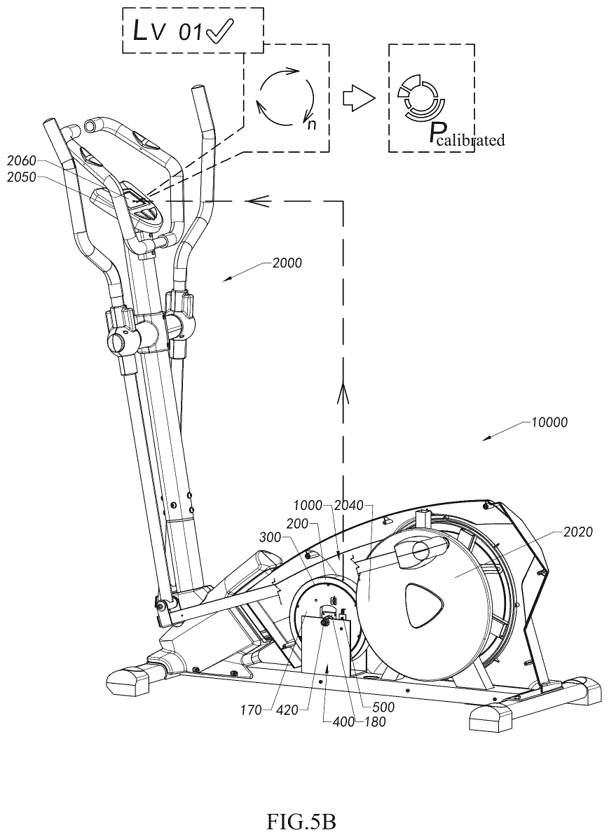

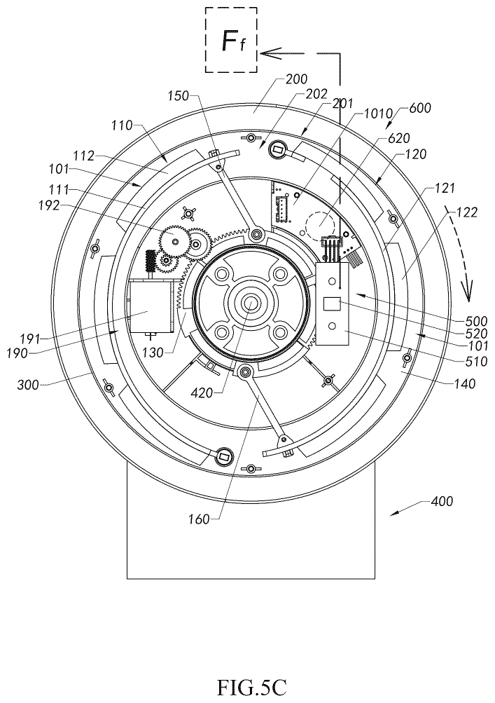

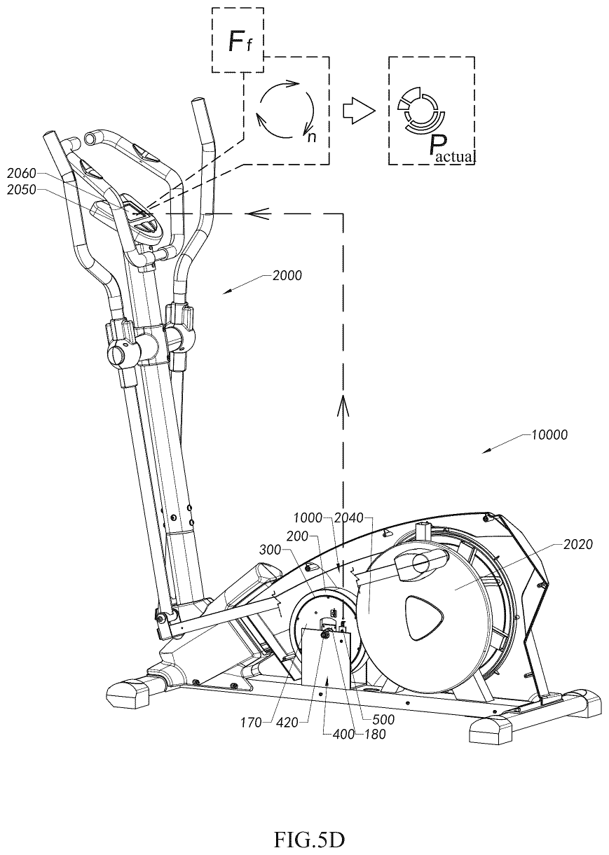

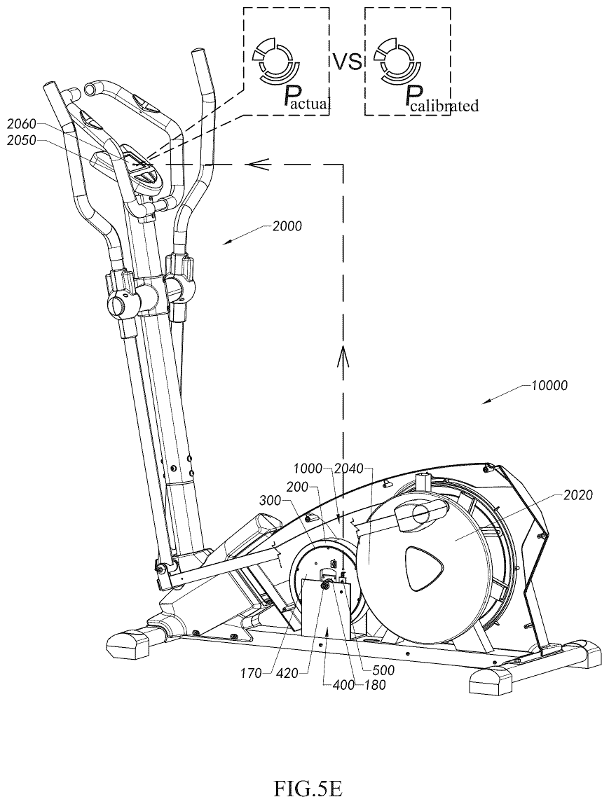

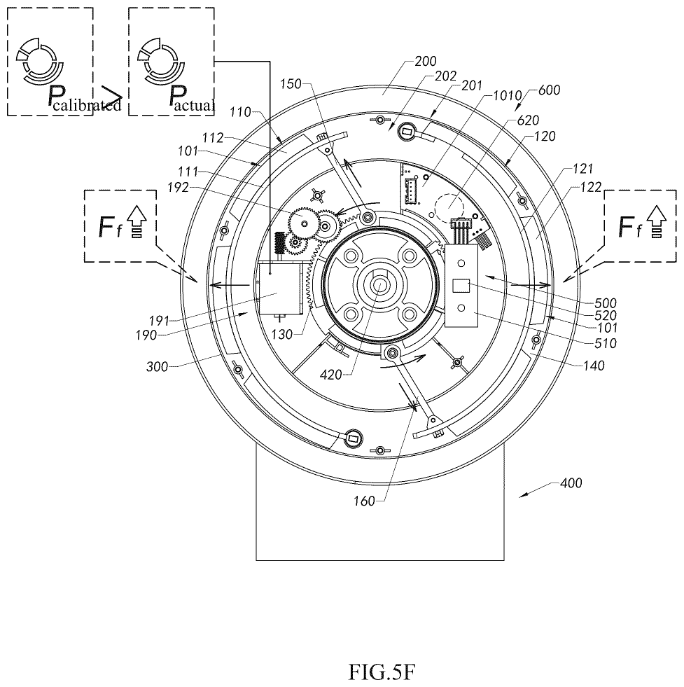

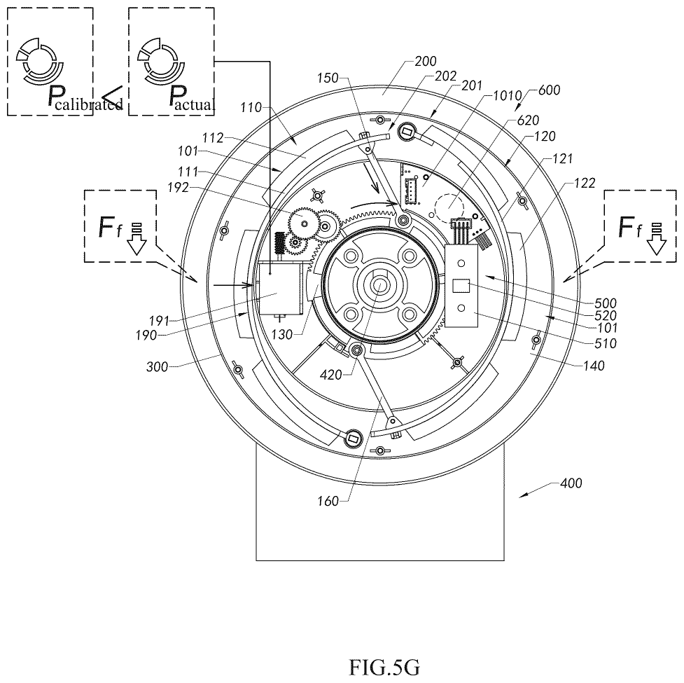

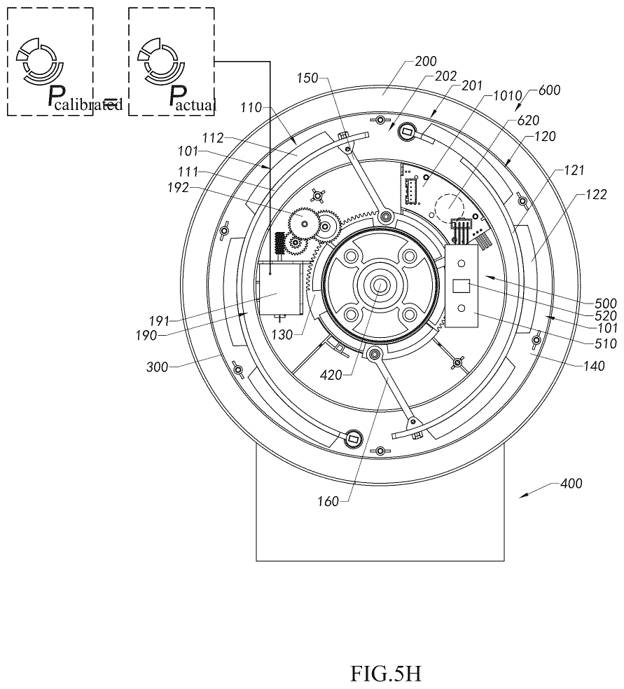

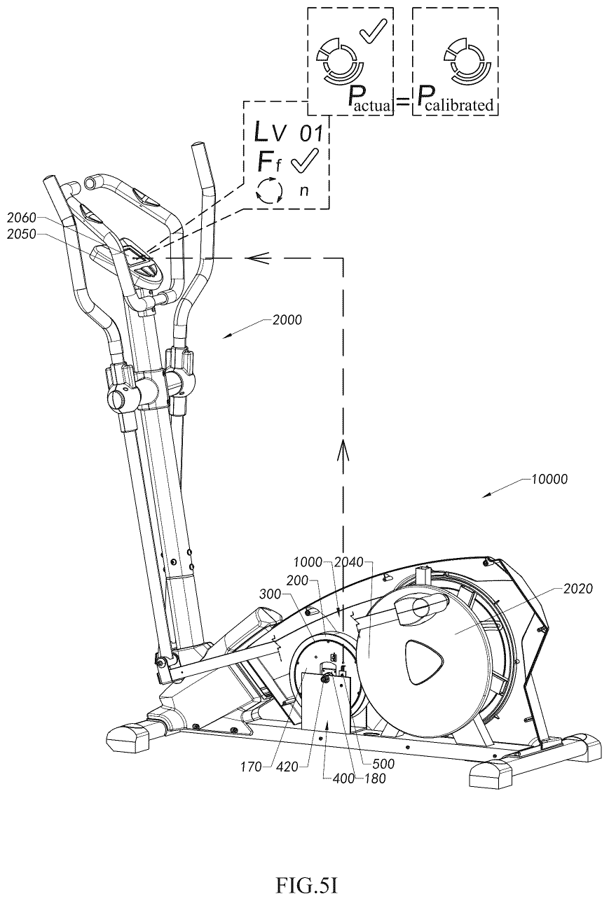

For example, referring to FIGS. 5A, 5B, 5C, and 5D, a user, when using the sport device 10000, selects a level control command “Level 1” via the equipment body 2000, and the user, after actuating the equipment body 2000 and the resistance adjusting device 1000, the rotation speed sensor 620 detects a rotation speed of “n” and the torque detecting device 500 detects a torque of “F”. At this time, the control module 1010 obtains the corresponding calibrated power of the sport device 10000 as “P_{calibrated}” based on the level command “level 1” and the rotation speed “n”. At the same time, the control module 1010 calculates the actual power of the user as “P_{actual}” based on the rotation speed “n” and the torque “F”.

Referring to FIGS. 5E to 5I, the control module 1010 compares the users actual power “P_{actual}” with the calibrated power “P_{calibrated}” of the sport device 10000. Referring to FIGS. 5G, 5H, and 5I, if the users actual power “P_{actual}” is greater than the calibrated power “P_{calibrated}” of the sport device 10000, the control module 1010 controls the driving motor 191 to drive the rotating member 130 clockwise and the first magnetic tile 110 and the second magnetic tile 120 are pulled closer to each other. The distance between the magnetic conductive surface 201 of the rotating wheel 200 and the magnetic surface 101 of the first magnetic tile 110 and the magnetic surface 101 of the second magnetic tile 120 is increased and the torque detected by the torque detecting device 500 is decreased. Until it is adjusted until the actual power “P_{actual}” of the user obtained based on the detection results of the torque detecting device 500 is equal to the calibrated power “P_{calibrated}” of the sport device 10000, then the first magnetic tile 110 and the second magnetic tile 120 are held in a position, to ensure the actual power “P_{actual}” of the user is equal to the calibrated power “P_{calibrated}” of the sport device 10000.

Referring to FIGS. 5G, 5H, and 5I, if after the control module 1010 compares, the users actual power “P_{actual}” is less than the calibrated power “P_{calibrated}” of the sport device 10000, the control module 1010 controls the driving motor 191 to drive the rotating member 130 counterclockwise and the first magnetic tile 110 and the second magnetic tile 120 are pushed away from each other. The distance between the magnetic conductive surface 201 of the rotating wheel 200 and the magnetic surface 101 of the first magnetic tile 110 and the magnetic surface 101 of the second magnetic tile 120 is decreased and the torque detected by the torque detecting device 500 is increased. Until it is adjusted until the actual power “P_{actual}” of the user obtained based on the detection results of the torque detecting device 500 is equal to the calibrated power “P_{calibrated}” of the sport device 10000, then the first magnetic tile 110 and the second magnetic tile 120 are held in a position, to ensure the actual power “P_{actual}” of the user is equal to the calibrated power “P_{calibrated}” of the sport device 10000. That is to say, after the user selects the exercise level, the sport device 10000 adjusts the amount of resistance to which the user is subjected based on the difference between the calibrated power and the actual power of the user, in order to ensure that the actual power of the user and the calibrated power of the sport device 10000 are always the same. In this way, the power value that can be viewed by the user through the sport device 10000 is equal to the actual power.

In a specific embodiment of the present invention, the process of calculating the actual power, the process of obtaining the calibrated power, the control of the driving motor 191 based on the difference between the actual power and the calibrated power are achieved by an internal program installed in the control module 1010, and the control module 1010 directly feeds back the calibrated power, i.e., the actual power, to the control console 2050 of the equipment body 2000 and presenting the calibrated power, i.e. the actual power of the user, to the user via the display 2060 communicatively coupled to the control console 2050.

In another specific embodiment of the present invention, the process of calculating the actual power, the process of obtaining the calibrated power, the control of the driving motor 191 based on the difference between the actual power and the calibrated power are all carried out in an internal program of the control console 2050 of the equipment body 2000, and the control console 2050 controls the driving motor 191 through the control module 1010 and the display 2060 shows the calibrated power, i.e. the actual power to the user. It should be understood by those skilled in the art that the specific manner in which data is processed by the sport device 10000 is not limited and cannot be a limitation on the content and scope of the resistance-adjustable rotating wheel 100 and adjusting method thereof, as well as the sport device 1000 of the present invention.

The torque detecting device 500 comprises a connecting member 510 and a torque sensing member 520, wherein the connecting member 510 comprises a strain portion 511, a fixed end 512 and an assembling end 513 extended integrally from two sides of the strain portion 511, wherein the torque sensing member 523 is provided in the strain portion 511. The fixed end 512 of the torque detecting device 500 is mounted at the fixing device 400, the strain portion 511 is mounted to the resistance adjusting device 100, the strain portion 511 is communicatively coupled to the control module 1010, and the strain portion 511 is capable of detecting the amount of torque to which the resistance adjusting device 100 is subjected.

Referring to FIG. 2, preferably, the fixed end 512 of the connecting member 510 is secured at the supporting portion 412 of the fixing device 400, and the assembling end 513 of the connecting member 510 is secured at the outer cover 170 of the resistance adjusting device 100.

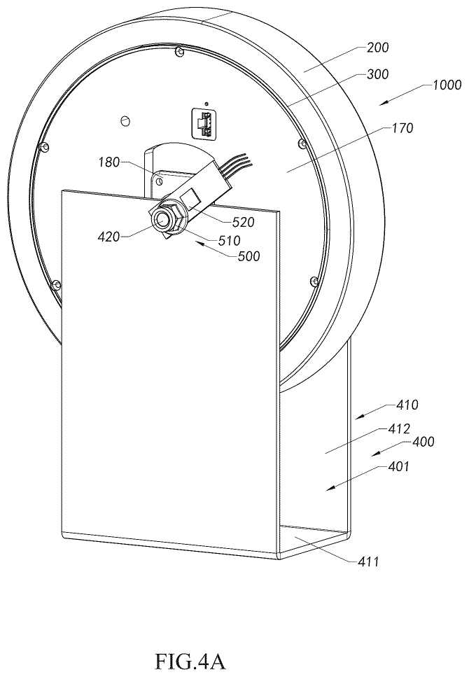

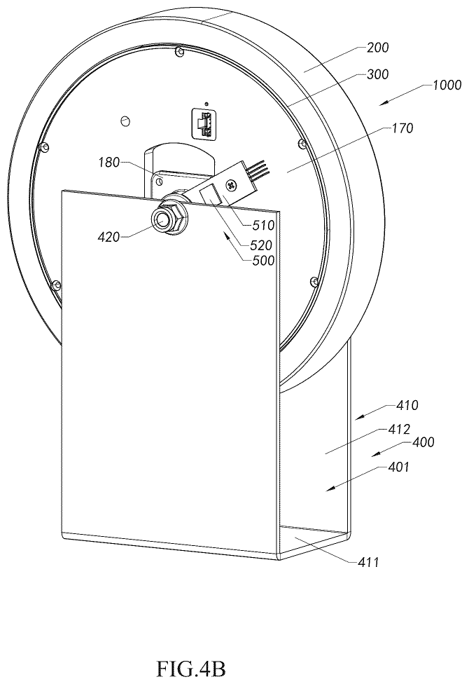

Referring to FIG. 4B, optionally, the fixed end 512 of the connecting member 510 is secured at the supporting portion 412 of the fixing device 400, and the assembling end 513 of the connecting member 510 is secured at the assembling portion 182 of the flange 180 of the resistance adjustment device 100.

Referring to FIG. 4A, optionally, the fixed end 512 of the connecting member 510 is secured at the assembling shaft 420 of the fixing device 400, and the assembling end 513 of the connecting member 510 is secured at the outer cover 170 of the resistance adjusting device 100.

Optionally, the fixed end 512 of the connecting member 510 is secured at the assembling shaft 420 of the fixing device 400, and the assembling end 513 of the connecting member 510 is secured at the assembling portion 182 of the flange 180 of the resistance adjustment device 100.

It is worth mentioning that the specific implementation of the torque detecting device 500 is not limited, and the torque detecting device 500 may be implemented as a torque sensor, a torque sensor, a torque transducer and the like. Moreover, the specific mounting position of the torque detecting device 500 is merely exemplary and cannot be a limitation on the content and scope of the resistance-adjustable rotating wheel 1000 and the sport device 10000 of the present invention.

According to an aspect of the present invention, the present invention provides an adjusting method for a resistance-adjustable rotating wheel 1000, wherein the adjusting method comprises the following steps:
(a) obtaining a calibrated power corresponding to a sport device 10000 based on a received level control command and a rotation speed of a rotating wheel 200 of a resistance-adjustable rotating wheel 1000;
(b) detecting a torque of a resistance adjusting device 100 of the resistance-adjustable rotating wheel 1000 and calculating an actual power of the user; and
(c) adjusting the distance between a magnetic surface 101 of the resistance adjusting device 100 and a magnetic conductive surface 201 of the rotating wheel 200 based on the difference between the calibrated power and the actual power, until the users actual power is substantially equal to the calibrated power of the sport device 10000.

Specifically, in the step (c), if the actual power is less than the calibrated power, increasing the distance between the magnetic surface 101 of the resistance adjusting device 100 and the magnetic conductive surface 201 of the rotating wheel 200, and thus increasing the torque of the resistance adjusting device 100, in order to increase the actual power of the user. More specifically, if the actual power of the user is less than the calibrated power of the sport device 10000, driving the rotating member 130 of the resistance adjusting device 100 to rotate counterclockwise, so as to push the first magnetic tile 110 and the second magnetic tile 120 in a direction close to the magnetic conductive surface 201 of the rotating wheel 200.

In the step (c), if the actual power is greater than the calibrated power, decreasing the distance between the magnetic surface 101 of the resistance adjusting device 100 and the magnetic conductive surface 201 of the rotating wheel 200, and then, decreasing the torque of the resistance adjusting device 100 to decrease the actual power of the user. If the actual power of the user is less than the calibrated power of the sport device 10000, driving the rotating member 130 of the resistance adjusting device 100 to rotate clockwise, so as to pull the first magnetic tile 110 and the second magnetic tile 120 in a direction away from the magnetic conductive surface 201 of the rotating wheel 200.

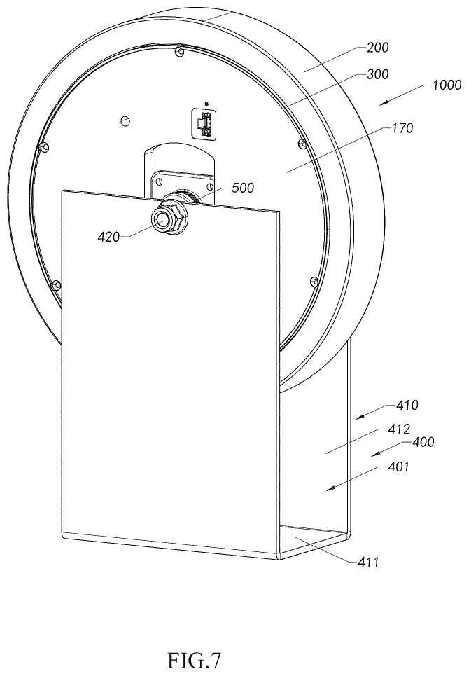

Referring to FIGS. 7 to 101 of the accompanying drawings, a sport device 10000 according to another preferred embodiment of the present invention will be described in the ensuing description, wherein an actual power of a user when exercising through the sport device 10000 and a calibrated power of the sport device 10000 are substantially equivalent, significantly improving the quality grade of the sport device 10000.

Specifically, the sport device 10000 comprises a resistance-adjustable rotating wheel 1000 and an equipment body 2000, wherein the resistance-adjustable rotating wheel 100 comprises a resistance-adjusting device 100, a rotating wheel 200, a metal spacer 300, a fixing device 400, and a torsion detection flange 500. The rotating wheel 200 is rotatably mounted at the resistance adjusting device 100, the metal spacer 300 is held between the resistance adjusting device 100 and the rotating wheel 200. The resistance detecting device 500 is mounted at the fixing device 400, one end of the torque detecting device 500 is connected with the resistance adjusting device 100 and another end of the torsion detection flange 500 is the fixing device 400. The rotating wheel 200 of the resistance-adjustable rotating wheel 1000 is drivably connected to the equipment body 2000, the torsion detection flange 500 is used to detect in real time the amount of torque to which the resistance adjusting device 100 is subjected during the rotation of the rotating wheel 200 with respect to the resistance adjusting device 100, in order to calculate, subsequently, the actual power of the user in the operation of the equipment body 2000, based on the amount of torque to which the resistance adjusting device 100 is subjected.

The torsion detection flange 500 is not only capable of being used to connect the fixing device 400 and the resistance adjusting device 100, but also the torsion detection flange 500 is capable of detecting the amount of torque to which the resistance adjusting device 100 is subjected when the rotating wheel 200 is rotating with respect to the resistance adjusting device 100, which simplifies the structure of and the assembling process of the resistance adjusting rotating wheel 1000, and not only make the structure of the resistance-adjustable rotating wheel 1000 more compact, but also contribute to the reduction of the assembling cost.

In this particular embodiment of the present invention, the resistance adjusting device 100 has a magnetic surface 101 and the rotating wheel 200 has a magnetic conductive surface 201 and a receiving space 202. The rotating wheel 200 is held at an outer side of the resistance adjusting device 100 in such a way that the magnetic conductive surface 201 is corresponded to the magnetic surface 101 of the resistance adjusting device 100, the resistance adjusting device 100 is held within the receiving space 202 of the rotating wheel 200. Moreover, the rotating wheel 200 is capable of being driven to rotate relative to the resistance adjusting device 100. For example, but not limited to, the user can drive the rotating wheel 200 to rotate relative to the resistance adjusting device 100 by foot pedal, stomp, foot tread, hand crank, etc., and the user exercises and works out while driving the rotating wheel 200 to rotate relative to the resistance adjusting device 100. The metal spacer 300 is held between the magnetic surface 101 of the resistance adjusting device 100 and the magnetic conductive surface 201 of the rotating wheel 200. Further, the resistance adjusting device 100 is operatively held at a side of the rotating wheel 200, and the resistance adjusting device 100 is capable of adjusting the amount of resistance to which the rotating wheel 200 is subjected by adjusting the distance between the magnetic surface 101 and the magnetic conductive surface 201 of the rotating wheel 200. In this way, the user is allowed to select different levels of resistance in order to achieve suitable workout intensity.

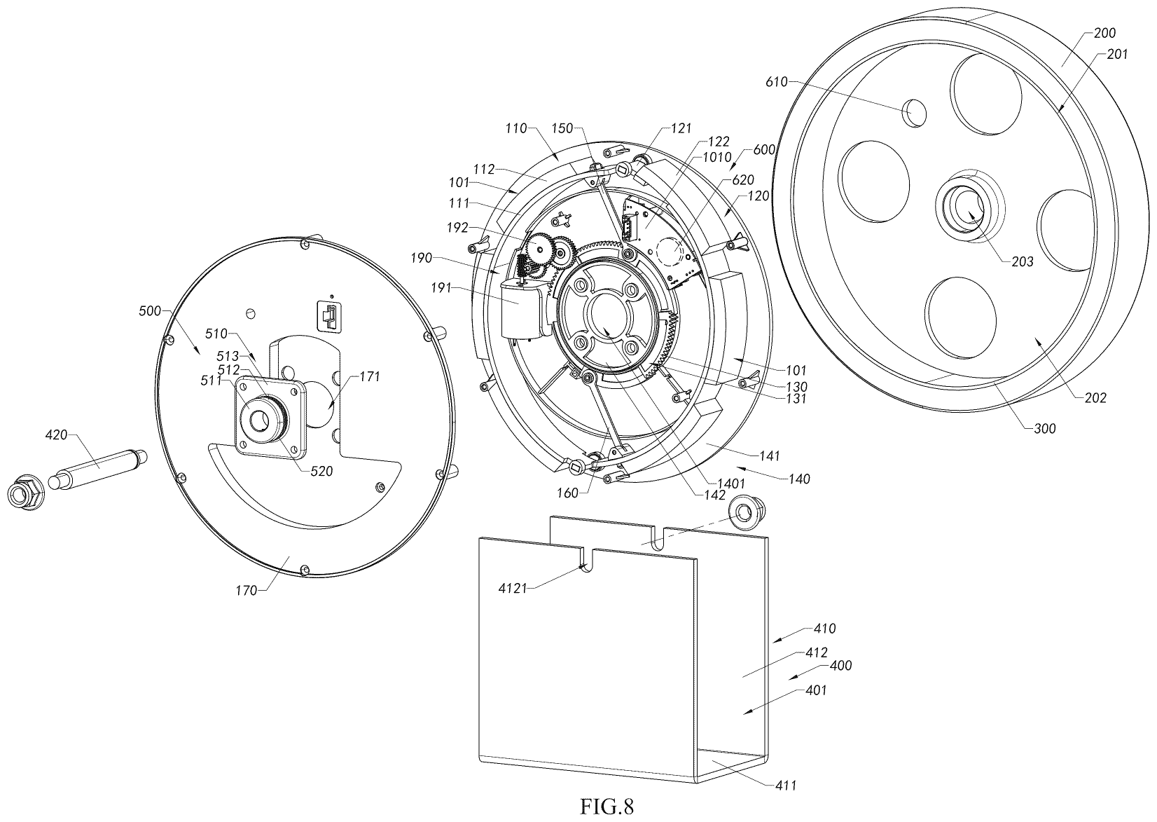

Specifically, referring to FIG. 8, the resistance adjusting device 100 comprises a first magnetic tile 110, a second magnetic tile 120, a rotating member 130, and a base plate 140, wherein each of the first magnetic tile 110 and the second magnetic tile 120 has a magnetic surface 101. The rotating member 130 is rotatably mounted at the base plate 140, and the first magnetic tile 110 and the second magnetic tile 120 are movably held at two sides of the rotating member 130.

The rotating wheel 200 is implemented to be made of metal, i.e., the magnetic conductive surface 101 of the rotating wheel 200 is metallic, and the rotating wheel 200 is rotatably held at an outside of the first magnetic tile 110 and the second magnetic tile 120 in such a manner that the magnetic conductive surface 201 is corresponded to the magnetic surfaces 101 of the first magnetic tile 110 and the second magnetic tile 120. The metal spacer 300 is held between the magnetic conductive surface 101 of the rotating wheel 200 and the magnetic surfaces 101 of the resistance adjusting device 100 in a manner that is mounted to the magnetic conductive surface 101 of the rotating wheel 200. During the process of the rotating member 130 of the resistance adjusting device 100 rotates relative to the base plate 140, the rotating member 130 drives the first magnetic tile 110 and the second magnetic tile 120 to move relative to each other and make the first magnetic tile 110 and the second magnetic tile 120 to move closer to each other or farther away from each other, thereby adjusting the resistance to which the rotating wheel 200 is subjected during rotation.

More specifically, the first magnetic tile 110 and the second magnetic tile 120 are spacedly held at two sides of the rotating member 130, and when the first magnetic tile 110 and the second magnetic tile 120 move close to each other, the magnetic surface 101 of the first magnetic tile 110 and the magnetic surface 101 of the second magnetic tile 120 get closer to each other, and at the same time, the magnetic surface 101 of the first magnetic tile 110 and the magnetic surface 101 of the second magnetic tile 120 move in a direction away from the magnetic conductive surface 201 of the rotating wheel 200. At this point, the resistance the rotating wheel 200 is subjected to is reduced, as the rotating wheel 200 rotates relative to the resistance adjusting device 100.

When the first magnetic tile 110 and the second magnetic tile 120 move away each other, the magnetic surface 101 of the first magnetic tile 110 and the magnetic surface 101 of the second magnetic tile 120 move away from each other, and at the same time, the magnetic surface 101 of the first magnetic tile 110 and the magnetic surface 101 of the second magnetic tile 120 move in a direction away from the magnetic conductive surface 201 of the rotating wheel 200. At this point, the resistance the rotating wheel 200 is subjected to is increased, as the rotating wheel 200 rotates relative to the resistance adjusting device 100.

In this specific embodiment of the present invention, the resistance adjusting device 100 further comprises a first linkage member 150 and a second linkage member 160, wherein two ends of the first linkage member 150 are rotatably connected with an upper portion of the rotating member 130 and an upper portion of the first magnetic tile 110, respectively, and two ends of the second linkage member 160 are rotatably connected with a lower portion of the rotating member 130 and a lower portion of the second magnetic tile 120, respectively. A lower portion of the first tile 110 is rotatably mounted at a lower portion of the base plate 140 and an upper portion of the second tile 120 is rotatably mounted at an upper portion of the base plate 140. During process of the rotating member 130 rotates relative to the base plate 140, the rotating member 130 drives the first linkage member 150 and the second linkage member 160 to move, and the first linkage member 150 and the second linkage member 160 drive the first magnetic tile 110 and the second magnetic tile 120 to move, respectively, such that the first tile 110 and the second tile 120 can move closer to each other or further away from each other.

For example, when the rotating member 130 is driven to rotate clockwise with respect to the base plate 140, the rotating member 130 drives the first linkage member 150 to move from left to right, while the rotating member 130 drives the second linkage member 160 to move from right to left. The first linkage member 150 pulls the first magnetic tile 110, the lower portion of the first magnetic tile 110 rotates clockwise relative to the base plate 140, the upper portion of the first magnetic tile 110 gets closer to the rotating member 130 and the upper portion of the second magnetic tile 120, and the magnetic surface 101 of the first magnetic tile 110 moves in a direction away from the magnetic conducting surface 201 of the rotating wheel 200. The second linkage member 160 pulls the second magnetic tile 120, the upper portion of the second magnetic tile 120 rotates clockwise relative to the base plate 140, the second magnetic tile 120 moves closer to the rotating member 130 and the lower portion of the first magnetic tile 110, and the magnetic surface 101 of the second magnetic tile 120 moves in a direction away from the magnetic conductive surface 201 of the rotating wheel 200. During the process, the distance between the magnetic surface 101 of the resistance adjusting device 100 and the magnetic conductive surface 201 of the rotating wheel 200 is gradually increased, and the resistance subjected to by the rotating wheel 200 is gradually decreased as the rotating wheel 200 is driven to rotate.

Further, when the rotating member 130 is driven to rotate counterclockwise with respect to the base plate 140, the rotating member 130 drives the first linkage member 150 to move from right to left, while the rotating member 130 drives the second linkage member 160 to move from left to right. The first linkage member 150 pushes the first magnetic tile 110, the lower portion of the first magnetic tile 110 rotates counterclockwise relative to the base plate 140, the upper portion of the first magnetic tile 110 gets further away from the rotating member 130 and the upper portion of the second magnetic tile 120, and the magnetic surface 101 of the first magnetic tile 110 moves in a direction closer to the magnetic conducting surface 201 of the rotating wheel 200. The second linkage member 160 pushes the second magnetic tile 120, the upper portion of the second magnetic tile 120 rotates counterclockwise relative to the base plate 140, the second magnetic tile 120 moves further away from the rotating member 130 and the lower portion of the first magnetic tile 110, and the magnetic surface 101 of the second magnetic tile 120 moves in a direction closer to the magnetic conductive surface 201 of the rotating wheel 200. During the process, the distance between the magnetic surface 101 of the resistance adjusting device 100 and the magnetic conductive surface 201 of the rotating wheel 200 is gradually decreased, and the resistance subjected to by the rotating wheel 200 is gradually increased as the rotating wheel 200 is driven to rotate relative to the resistance adjusting device 100.

That is to say, the resistance adjusting device 100 described in the present invention can easily drive the first magnetic tile 110 and the second magnetic tile 120 closer to or farther away from each other by utilizing the rotating member 130, the first linkage member 15 and the second linkage member 160, which has a simple structure and a compact fit. The resistance adjusting device 100 not only simplifies the overall structure of the resistance adjusting device but also makes the resistance adjusting device smoother in the actual adjusting process, greatly reduces the failure rate and power consumption of the resistance adjusting device 100, and, at the same time, brings a better using experience to the user.

It is worth mentioning that driving the first magnetic tile 110 and the second magnetic tile 120 closer to each other and farther away from each other by driving the rotating member 130 of the resistance adjusting device 100 to rotate clockwise and counterclockwise can enlarge the range of motion of the first magnetic tile 110 and the second magnetic tile 120. In this way, the resistance to which the rotating wheel 200 is subjected during its rotation with respect to the resistance adjusting device 100 is allowed to be adjusted in a larger range, and there can be a clear difference between two different levels of resistance, which is conducive to satisfying the users need for different exercise intensities and further improving the users experience.

In a specific embodiment of the present invention, the first linkage member 150 is maintained to be inclinedly connected with the first magnetic tile 110 and the rotating member 130. The second linkage member 160 is maintained to be inclinedly connected with the second magnetic tile 120 and the rotating member 130. Preferably, an angle of inclination between the first linkage member 150 and the first magnetic tile 110 is always greater than or equal to 90°. An angle of inclination between the second linkage member 160 and the second magnetic tile 120 is always greater than or equal to 90°. In this way, the rotating member 130 can easily drive the first linkage member 150, the second linkage member 160, the first magnetic tile 110 and the second magnetic tile 120 to move, so as to enable the resistance adjusting device 100 to smoothly adjust the amount of resistance to which the rotating wheel 200 is subjected during rotation.

Preferably, the first linkage member 150 and the second linkage member 160 have the same length, the first linkage member 150 and the second linkage member 160 are maintained parallel to each other and provided above and below the rotating member 130, respectively, and a connection position between the first linkage member 150 and the rotating member 130, a center of the rotating member 130, a connection position between the second linkage member 150 and the rotating member 130 are located at the same straight line, and the distance and range of synchronized movement of the first magnetic tile 110 and the second magnetic tile 120 are maintained to be consistent with each other.

Alternatively, the first linkage member 150 and the second linkage member 160 are not of the same length, and the first linkage member 150 and the second linkage member 160 are not inclined at the same angle. It should be understood by those skilled in the art that the specific implements of the first linkage member 150 and the second linkage member 160 are merely exemplary and cannot be a limitation to the content and scope of the resistance adjusting device 100 of the present invention.

Referring to FIG. 8, in this specific embodiment of the present invention, the first magnetic tile 110 comprises a first load-bearing element 111 and at least one first magnetic block 112, wherein the magnetic surface 101 of the first magnetic tile 110 is formed on an outer surface of the first magnetic block 112. The first magnetic block 112 is mounted at the first load-bearing element 111 in such a way that the magnetic surface 101 faces outward. For example, but not limited to, the first magnetic block 112 is fixed at the first load-bearing element 111 by gluing, embedding, or other means known to those skilled in the art.

The second magnetic tile 120 comprises a second load-bearing element 121 and at least one second magnetic block 122, wherein the magnetic surface 101 of the second magnetic tile 120 is formed on an outer surface of the second magnetic block 122. The second magnetic block 122 is mounted at the second load-bearing element 121 in such a way that the magnetic surface 101 faces outward. For example, but not limited to, the second magnetic block 112 is fixed at the second load-bearing element 121 by gluing, embedding, or other means known to those skilled in the art.

Specifically, the magnetic conductive surface 201 of the rotating wheel 200 and the magnetic surfaces 101 of the magnetic blocks of the resistance adjusting device 100 define an external magnetic field therebetween, wherein when the rotating wheel 200 is driven to rotate with respect to the resistance adjusting device 100, the metal spacer 300 moves following the rotating wheel 200, and when the metal spacer 300 passes by a left edge of the magnetic blocks of the resistance adjusting device 100, a magnetic field experienced by the metal spacer 300 has a greater magnetic field strength and a counterclockwise eddy current is generated, and the eddy current generates an internal magnetic field, the direction of the internal magnetic field is opposite to the direction of the external magnetic field, which in turn generates a magnetic resistance. When the magnetic surfaces 101 of the magnetic blocks of the resistance adjusting device 100 is close to the magnetic conductive surface 201 of the rotating wheel 200, the magnetic resistance is increased and the rotating wheel 200 is subjected to increased resistance during rotation. When the magnetic surfaces 101 of the magnetic blocks is away from the magnetic conductive surface 201 of the rotating wheel 200, the magnetic resistance is decreased and the rotating wheel 200 is subjected to less resistance while rotating.

Preferably, the first magnetic tile 110 comprises a plurality of the first magnetic blocks 112 having the same size, the second magnetic tile 120 comprises a plurality of the second magnetic blocks 122 having the same size, wherein the plurality of the first magnetic blocks 112 are spacedly and evenly arranged on the first load-bearing element 111, the plurality of the second magnetic blocks 122 are spacedly and evenly arranged on the second load-bearing element 121. The plurality of the first magnetic blocks 112 and the plurality of the second magnetic blocks 122 surround an outer side of the rotating member 130 in such a manner that the magnetic surfaces 101 face outward. Optionally, the plurality of the first magnetic blocks 112 is not uniform in size. Optionally, the plurality of the second magnetic blocks 122 is not uniform in size. Optionally, the intervals of the first magnetic blocks 112 are inconsistent. Optionally, the intervals of the second magnetic blocks 122 are inconsistent.

It is worth mentioning that the specific implements of the first magnetic tile 110 and the second magnetic tile 120 illustrated in the specification and the accompanying drawings are intended as examples only, and cannot be a limitation to the content and scope of the resistance adjusting device 100 described in the present invention.

In this specific embodiment of the resistance-adjustable rotating wheel 1000 of the present invention, the base plate 140 of the resistance-adjusting device 100 comprises a carrying platform 141 and a cylindrical assembling convex plate 142 extended outwardly from the carrying platform 141, wherein the rotating member 130 has a circular assembling opening 131, the rotating member 130 is mounted at the carrying platform 141 in such a manner that the assembling opening 131 is corresponded to the assembling convex plate 142. The assembling convex plate 142 of the base plate 140 is held in the assembling opening 131 of the rotating member 130, an inner surface of the assembling opening 131 defined by the rotating member 130 is attached with an outer surface of the assembling convex plate 142 to facilitate the rotating member 130 maintaining a smooth rotation.

The fixing device 400 further comprises a fixing base 410 and an assembling shaft 420, wherein the fixing base 410 comprises a fixed portion 411 and two support portions 412 spaced from each other, wherein each of the support portions 412 has an assembling hole 4121, and wherein the two support portions 412 are extended upwardly from two sides of the fixed portion 411, and the fixed portion 411 and the two support portions 412 form a rotation space 401 therebetween, wherein the assembling holes 4121 of the support portions 412 are communicated with the rotation space 401. Two ends of the assembling shaft 420 are secured in the support portions 412, respectively.

The base plate 140 of the resistance adjusting device 100 of the resistance-adjustable rotating wheel 1000 further has an assembling channel 1401, wherein the assembling channel 1401 runs through the assembling convex plate 142 and the carrying platform 141, wherein the rotating wheel 200 further has a mounting hole 203, wherein the rotating wheel 200 is held at a side of the resistance adjusting device 100 in a manner that the mounting hole 203 is corresponded to the assembling channel 1401 of the base plate 140. The assembling shaft 420 is mounted in the assembling channel 1401 of the base plate 140 and the mounting hole 203 of the rotating wheel 200. during use, the fixing portion 411 of the fixing base 410 is secured to the ground, and the rotating wheel 200 is capable of being driven to move with respect to the resistance adjusting device 100, the fixing base 410, and the assembling shaft 420.

The resistance adjusting device 100 further comprises an outer cover 170, wherein the outer cover 170 has a through hole 171, wherein the outer cover 170 is held at a side of the resistance adjusting device 100 in such a manner that the through hole 171 is corresponded to the assembling shaft 420 and shelters an opening of the receiving space 202 of the rotating wheel 200, so that the resistance adjusting device 100 can be concealed within the receiving space 202 of the rotating wheel 200, which not only reduces contamination of the resistance adjusting device 100 and the interior of the rotating wheel 200, but also contributes to increasing the safety of use of the resistance-adjustable rotating wheel 1000.

In this specific implement of the resistance adjusting device 100 of the present invention, the resistance adjusting device 100 further comprises a driving assembly 190, wherein the driving assembly 190 comprises a driving motor 191 and a transmission gear set 192, wherein the driving motor 191 and the transmission gear set 192 are mounted at the base plate 140, wherein the driving motor 191 and the transmission gear set 192 are located at a side of the rotating member 130, and the transmission gear set 192 is located between the driving motor 191 and the rotating member 130. The rotating member 130 has a plurality of gear teeth matching the gear teeth of the transmission gear set 192, and the driving motor 191 is capable of driving the transmission gear set 192 to rotate to drive the rotating member 130 to rotate clockwise or counterclockwise with respect to the base plate 140, and thereby drive the first magnetic tile 110 and the second magnetic tile 120 close to each other or away from each other by the first linkage member 150 and the second linkage member 160, thereby adjust the amount of resistance to which the rotating wheel 200 is subjected during rotation.

Referring to FIG. 8, the torsion detection flange 500 comprises a flange body 510 and a torque sensing member 520, wherein the flange body 510 comprises a locking portion 511, a strain portion 512 and an assembling portion 513, wherein the locking portion 511 and the assembling portion 513 are extended integrally and outwardly from two sides of the locking portion 511, respectively. The locking portion 511 of the flange body 510 is fixedly mounted to an end of the assembling shaft 420 of the fixing device 400, and the assembling portion 513 is fixedly mounted to the outer cover 170 of the resistance adjusting device 100. The torque sensing member 520 is provided at the strain portion 512 of the flange body 510 in a manner that the torque sensing member 520 is attached on the strain portion 512. During process of the rotating wheel 200 rotates relative to the resistance adjusting device 100, the torque sensing member 520 detects the amount of torque to which the resistance adjusting device 100 is subjected.

In a specific embodiment of the present invention, the locking portion 511 of the flange body 510 is mounted to the assembling shaft 420 by a key connection. Optionally, the locking portion 511 is mounted at the assembling shaft 420 by a pinned connection. Optionally, the locking portion 511 is mounted to the assembling shaft 420 by a threaded connection. In a specific embodiment of the present invention, the assembling portion 513 of the flange body 510 is mounted at the cover 170 by a screw, bolt or stud connection, etc. It should be understood by those skilled in the art that the specific manner in which the locking portion 511 of the flange body 510 is coupled to the assembling shaft 420, and the assembling portion 513 is coupled to the cover 170, are merely exemplary and cannot be a limitation on the content and scope of the torsion detection flange 500, the resistance-adjustable rotating wheel 1000 and the sport device 10000 of the present invention.

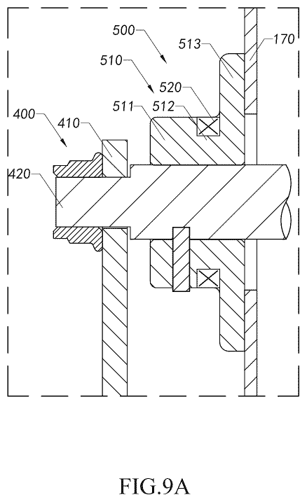

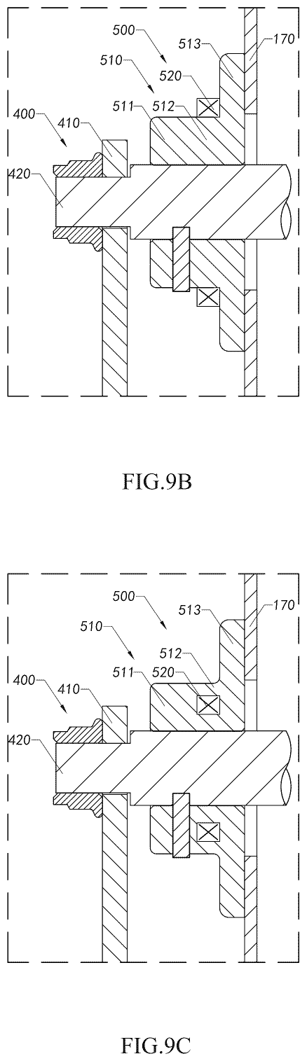

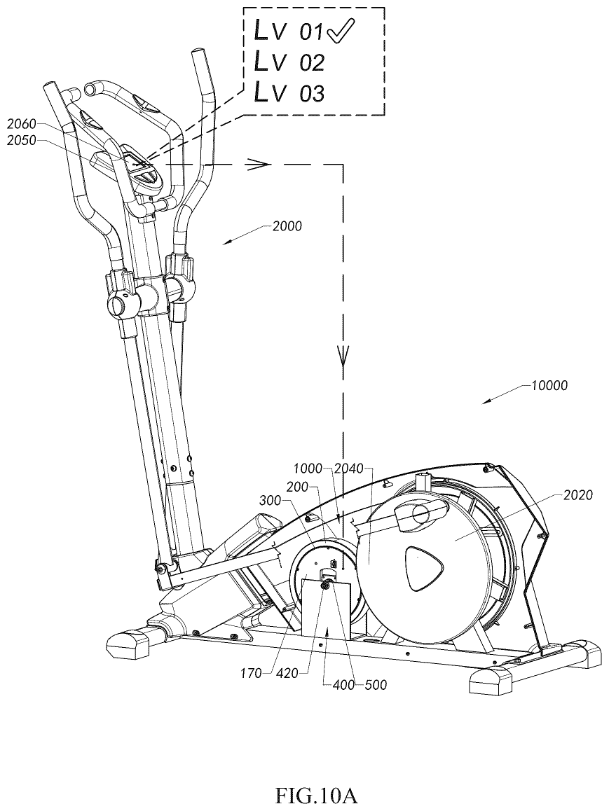

Referring to FIG. 9A, in a specific embodiment of the present invention, the strain portion 512 of the flange body 510 has an assembling groove, and an outer surface of the strain portion 512 is recessed inwardly to form the assembling groove 5120, and the torque sensing member 520 is embedded in the assembling groove 5120 in a manner that the torque sensing member 520 is attached on the outer surface of the strain portion 512. For example, but not limited to, the torque sensing member 520 is held in the assembling groove 5120 of the strain portion 512 by welding, gluing, or other means known to those skilled in the art.

Optionally, referring to FIG. 9B, the outer surface of the strain portion 512 is aligned with an outer surface of the locking portion 511, and the torque sensing member 520 is provided on the outer surface of the strain portion 512 in a manner that the torque sensing member 520 protrudes from the strain portion 512 and the locking portion 511. For example, but not limited to, the torque sensing member 520 is held in the outer surface of the strain portion 512 by welding, gluing, or other means known to those skilled in the art.

Optionally, referring to FIG. 9C, the torque sensing member 520 is concealed within the strain portion 512. For example, the flange body 510 is made by a process such as pour molding or injection molding, the torque sensing member 520 is placed in a preformed mold, and after pour molding or injection molding of the flange body 510, and the torque sensing member 520 is concealed within the strain portion 512 of the flange body 510.

It is worth mentioning that the specific location and implementation of the torque sensing member 520 are merely exemplary and cannot be a limitation on the content and scope of the torsion detection flange 500 of the present invention. The resistance-adjustable rotating wheel 1000 further comprises a rotation speed detecting assembly 600, wherein the rotation speed detecting assembly 600 comprises a sensing member 610 and a rotation speed sensor 620, wherein the sensing member 610 is disposed at the rotating wheel 200 and the rotation speed sensor 620 is disposed at the resistance adjusting device 100. The rotating wheel 200 is mounted at the resistance adjusting device 100 in such a manner that the sensing member 610 can face the speed sensor 620. During process of the rotating wheel 200 rotates with respect to the resistance adjusting device 100, the sensing member 610 rotates with respect to the rotation speed sensor 620, and when the sensing member 610 faces the rotation speed sensor 620, the rotation speed sensor 620 is capable of sensing the sensing member 610 and outputting a pulse signal corresponding to the rotational frequency of the sensing member 610, whereby the rotation speed of the sensing member 610 can be obtained to indirectly obtain the rotation speed of the rotating wheel 200.

For example, but not limited to, the rotation speed sensor 620 is implemented as a Hall sensor. Optionally, the rotation speed sensor 620 is mounted on the base plate 140. The specific mounting position of the rotation speed sensor 620 is merely exemplary and must not be a limitation on the content and scope of the resistance adjustment device 100 of the present invention.

The sensing member 610 is implemented as a magnetic material or a magnetic conductive material, for example, but not limited to, the sensing member 610 is implemented as a magnet. Preferably, the sensing member 610 is provided in the rotating wheel 200 in such a way that it protrudes from an inner surface of the rotating wheel 320.

That is to say, the rotation speed detecting assembly 600 is integrated inside the resistance adjusting device 100 and the rotating wheel 200, which simplifies the installation process of the rotation speed detecting assembly 600 and avoids the installation deviation of the rotation speed detecting assembly 600 during the cumbersome installation process from affecting the accuracy of the detection results. In other words, the rotation speed detecting assembly 600 of the present invention has a high detection accuracy, which, in this way, facilitates the improvement of the accuracy of the calculation results based on the rotation speed detected by the rotation speed detecting assembly 600.

The resistance adjusting device 100 further comprises a control module 1010, wherein the control module 1010 is communicatively coupled to the torsion detection flange 500 and the rotation speed sensor 620 of the rotation speed detecting assembly 600, wherein the control module 1010 can calculate the actual power of the user based on the torque detected by the torsion detection flange 500 and the rotation speed detected by the rotation speed sensor 620. Preferably, the rotation speed sensor 620 is mounted at the control module 1010.

The control module 101 is communicatively coupled to the equipment body 2000, the control module 1010 is capable of obtaining a level control command from the equipment body 2000, the control module 1010 can obtain a calibrated power of the sport device 10000 based on the level control command and the rotation speed detected by the rotation speed sensor 620. The correspondence between the level control command, the rotation speed, and the calibrated power of the sport device 10000 can be pre-set before it leaves factory.

Further, the control module 101 is communicatively coupled to the driving motor 191 of the driving assembly 190, and the control module 1010 controls the working state of the driving motor 191 based on the difference between the calibrated power of the sport device 10000 and the actual power of the user, for example, but not limited to rotating speed, rotation direction and rotation angle of the driving motor 191, thereby driving the first magnetic tile 110 and the second magnetic tile 120 closer to each other or farther away from each other to change the magnitude of the torque applied to the torque regulating device 100 until the actual power of the user obtained based on the magnitude of the torque applied to the torque regulating device 100 and the calibrated power of the sport device 10000 are consistent.

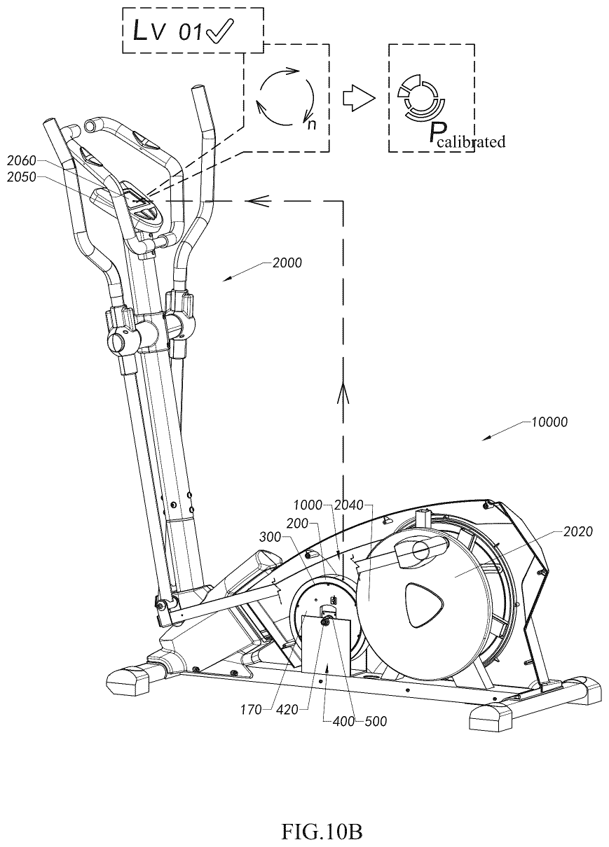

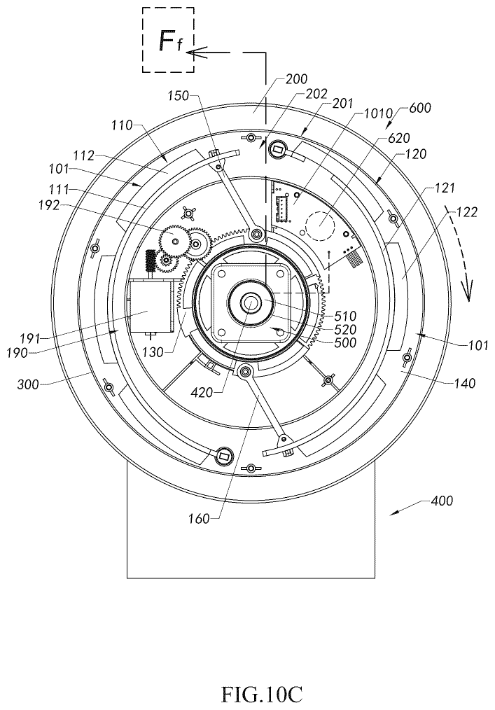

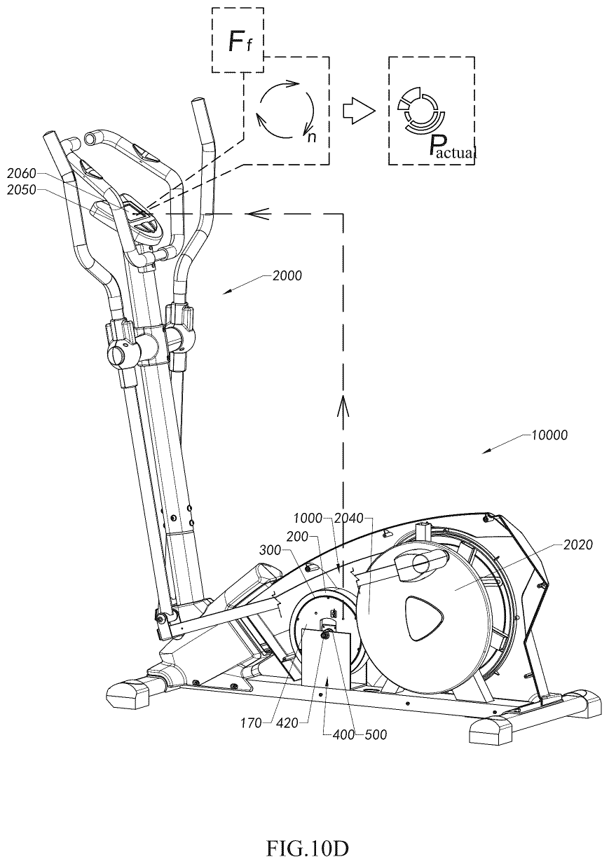

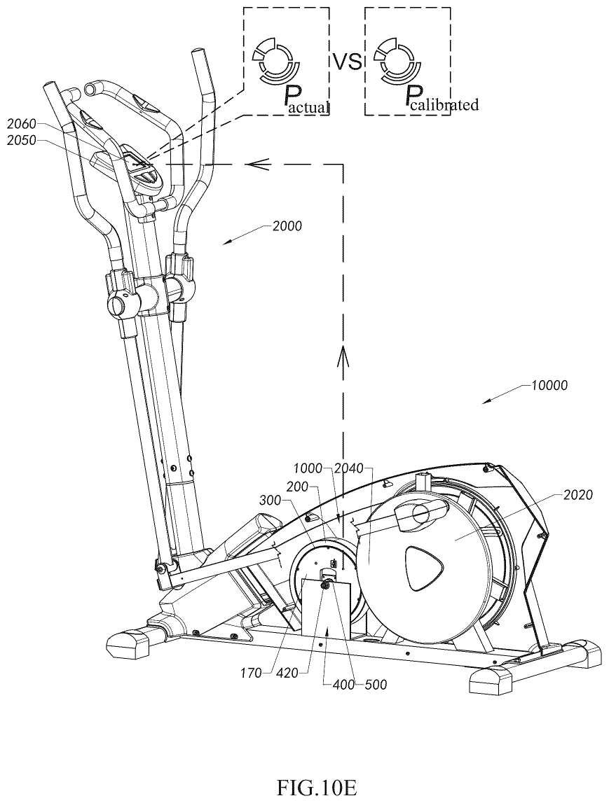

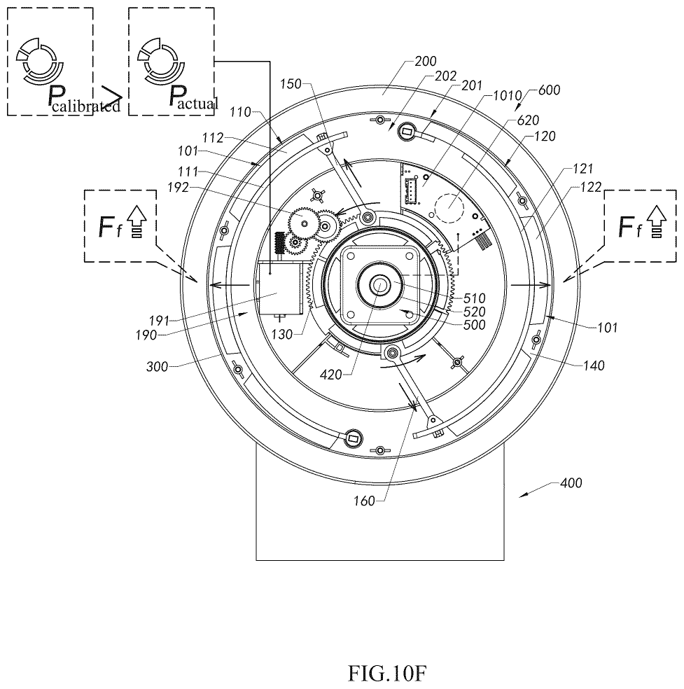

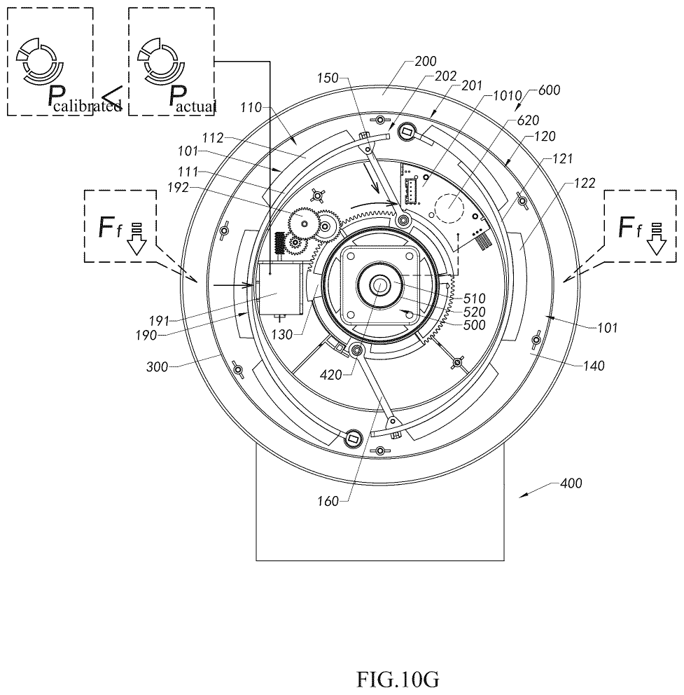

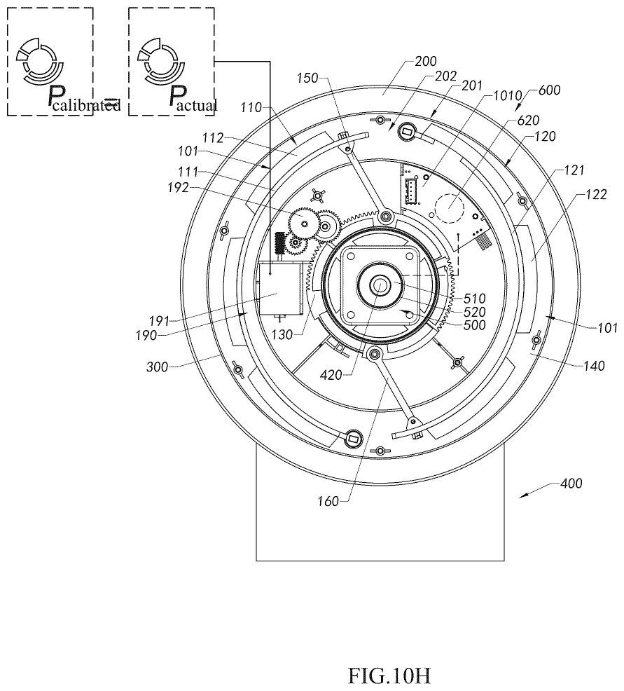

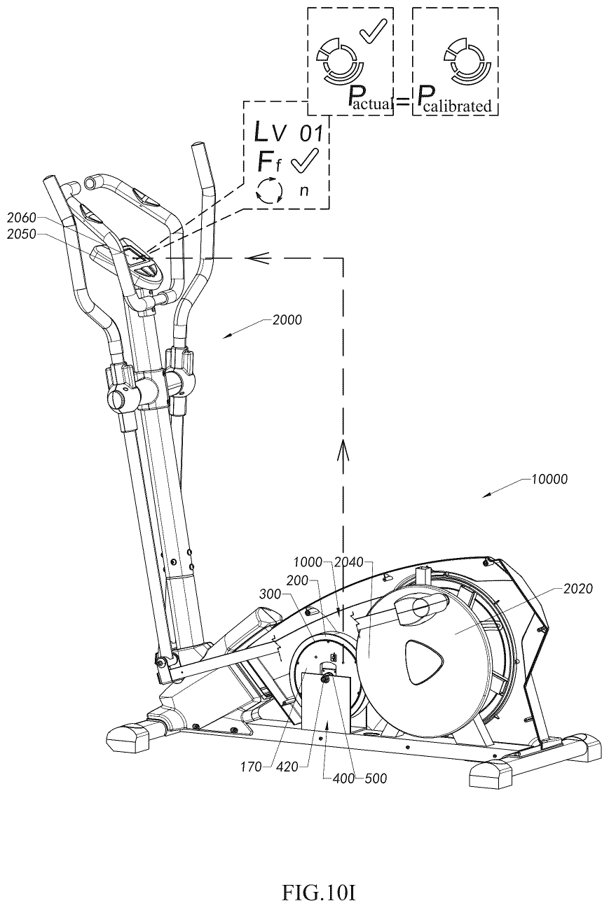

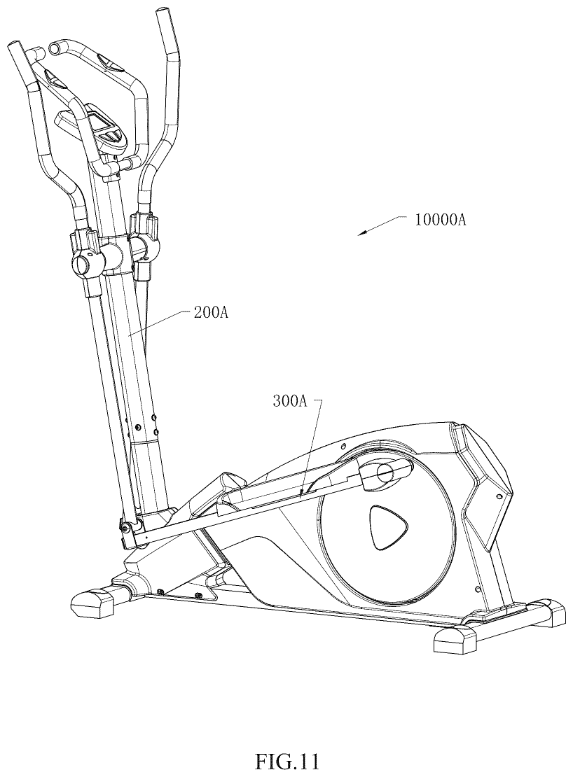

For example, referring to FIGS. 10A to 10D, a user, when using the sport device 10000, selects a level control command “Level 1” via the equipment body 2000, and the user, after actuating the equipment body 2000 and the resistance adjusting device 1000, the rotation speed sensor 620 detects a rotation speed of “n” and the torsion detection flange detects a torque of “F”. At this time, the control module 1010 obtains the corresponding calibrated power of the sport device 10000 as “P_{calibrated}” based on the level command “level 1” and the rotation speed “n”. At the same time, the control module 1010 calculates the actual power of the user as “P_{actual}” based on the rotation speed “n” and the torque “F”.

Referring to FIGS. 10E, the control module 1010 compares the users actual power “P_{actual}” with the calibrated power “P_{calibrated}” of the sport device 10000. Referring to FIGS. 10H to 10I, if the users actual power “P_{actual}” is greater than the calibrated power “P_{calibrated}” of the sport device 10000, the control module 1010 controls the driving motor 191 to drive the rotating member 130 clockwise and the first magnetic tile 110 and the second magnetic tile 120 are pulled closer to each other. The distance between the magnetic conductive surface 201 of the rotating wheel 200 and the magnetic surface 101 of the first magnetic tile 110 and the magnetic surface 101 of the second magnetic tile 120 is increased and the torque detected by the torsion detection flange 500 is decreased. Until it is adjusted until the actual power “P_{actual}” of the user obtained based on the detection results of the torsion detection flange 500 is equal to the calibrated power “P_{calibrated}” of the sport device 10000, then the first magnetic tile 110 and the second magnetic tile 120 are held in a position, to ensure the actual power “P_{actual}” of the user is equal to the calibrated power “P_{calibrated}” of the sport device 10000.

Referring to FIGS. 10F, 10H, and 10I, if after the control module 1010 compares, the users actual power “P_{actual}” is less than the calibrated power “P_{calibrated}” of the sport device 10000, the control module 1010 controls the driving motor 191 to drive the rotating member 130 counterclockwise and the first magnetic tile 110 and the second magnetic tile 120 are pushed away from each other. The distance between the magnetic conductive surface 201 of the rotating wheel 200 and the magnetic surface 101 of the first magnetic tile 110 and the magnetic surface 101 of the second magnetic tile 120 is decreased and the torque detected by the torsion detection flange 500 is increased. Until it is adjusted until the actual power “P_{actual}” of the user obtained based on the detection results of the torsion detection flange 500 is equal to the calibrated power “P_{calibrated}” of the sport device 10000, then the first magnetic tile 110 and the second magnetic tile 120 are held in a position, to ensure the actual power “P_{actual}” of the user is equal to the calibrated power “P_{calibrated}” of the sport device 10000. That is to say, after the user selects the exercise level, the sport device 10000 adjusts the amount of resistance to which the user is subjected based on the difference between the calibrated power and the actual power of the user, in order to ensure that the actual power of the user and the calibrated power of the sport device 10000 are always the same. In this way, the power value that can be viewed by the user through the sport device 10000 is equal to the actual power.

It is worth mentioning that, in a specific embodiment of the present invention, the process of calculating the actual power, the process of obtaining the calibrated power, the control of the driving motor 191 based on the difference between the actual power and the calibrated power are achieved by an internal program installed in the control module 1010, and the control module 1010 directly feeds back the calibrated power, i.e., the actual power, to a control console 2050 of the equipment body 2000 and presenting the calibrated power, i.e. the actual power of the user, to the user via a display 2060 communicatively coupled to the control console 2050. In another specific embodiment of the present invention, the process of calculating the actual power, the process of obtaining the calibrated power, the control of the driving motor 191 based on the difference between the actual power and the calibrated power are all carried out in an internal program of the control console 2050 of the equipment body 2000, and the control console 2050 controls the driving motor 191 through the control module 1010 and the display 2060 shows the calibrated power, i.e. the actual power to the user. The specific manner in which data is processed by the sport device 10000 is not limited and cannot be a limitation on the content and scope of the resistance-adjustable rotating wheel 100 and adjusting method thereof, as well as the sport device 1000 of the present invention.

In a specific embodiment of the present invention, the equipment body 2000 comprises a supporting frame 2010, a transmission wheel 2020, two driving members 2030, and a transmission belt 2040, wherein the transmission wheel 2020 is rotatably mounted at the supporting frame 2010, the driving members 2030 are operatively mounted at two side of the transmission wheel 2020, and the transmission wheel 2020 is connected with the rotating wheel 200 of the resistance-adjustable rotating wheel 1000 through the transmission belt 2040. During the driving member 2030 drives the transmission wheel 2020 to rotate relative to the supporting frame 2010, the transmission wheel 2020 drives the transmission belt 2040 and the rotating wheel 200 of the resistance-adjustable rotating wheel 1000 to rotate. The rotating wheel 200 rotates relative to the resistance adjusting device 100, and by changing the distance between the magnetic surface 101 of the resistance adjusting device 100 and the magnetic conductive surface 201 of the rotating wheel 200 to change the amount of resistance to which the rotating wheel 200 is subjected, and thus to adjust the amount of resistance to which the equipment body 2000 is subjected, so as to adjust the amount of resistance felt by a user when utilizing the equipment body 2000 to regulate the amount of resistance felt by the user while exercising.

It is worth mentioning that the specific implementation of the driving member 2030 is not limited, and the driving member 2030 is allowed to be driven by a foot pedal, a foot stirrup, a foot pedal, a hand crank, a hand push, a hand pull, and so on. And, the specific implementation of the equipment body 2000 is not limited, and the equipment body 2000 may be implemented as an elliptical machine, a kinetic bicycle, a rowing machine, or a sport device known to those skilled in the art. Moreover, it should be understood by those skilled in the art that the specific embodiments of the equipment body 2000 disclosed in the specification and the accompanying drawings are intended as examples only and are not to be a limitation on the content and scope of the sport device 10000 described herein.

The equipment body 2000 comprises the control console 2050 and the display 2060, wherein the display 2060 is communicatively connected with the control console 2050, and the control console 2050 is communicatively connected with the control module 1010 and the torsion detection flange 500 of the resistance adjusting device 100 of the resistance-adjustable rotating wheel 1000. The control console 2050 is capable of processing data obtained by the control module 1010 and the torsion detection flange 500 to obtain an exercise data of a user during an exercise session, wherein the exercise data is for example, but not limited to, exercise speed, exercise power, calories burned, exercise time, etc. The display 2060 displays the exercise data generated by the control console 2050 to facilitate the user to keep track of the exercise condition in real time.

Further, the display 2060 allows selection or input of a control command, the control console 2050 can send the control command to the control unit 1010 of the resistance adjusting device 100, the control unit 1010 controls the operating state of the driving motor 181 of the resistance adjusting device 100 based on the actual power of the user and the calibrated power of the sport device 10000, to change the direction of rotation and angle of rotation of the rotating member 130, thereby adjusting the distance between the magnetic surfaces 101 of the first magnetic tile 110 and the second magnetic tile 120 and the magnetic conductive surface 201 of the rotating wheel 200, and ensuring that the actual power of the user and the calibrated power of the sport device 10000 are consistent.

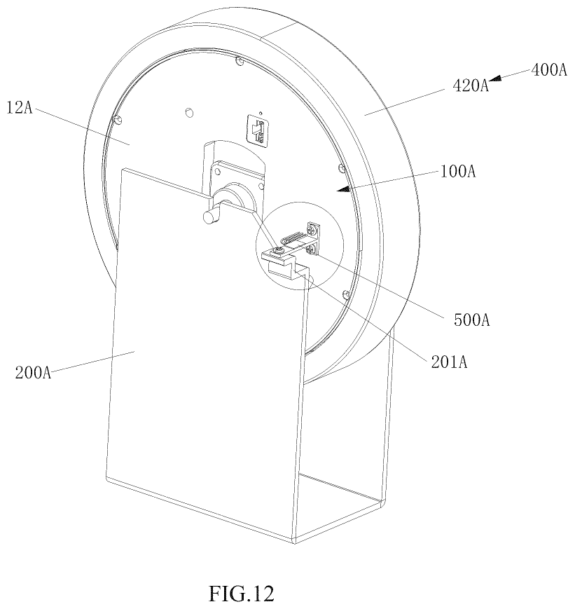

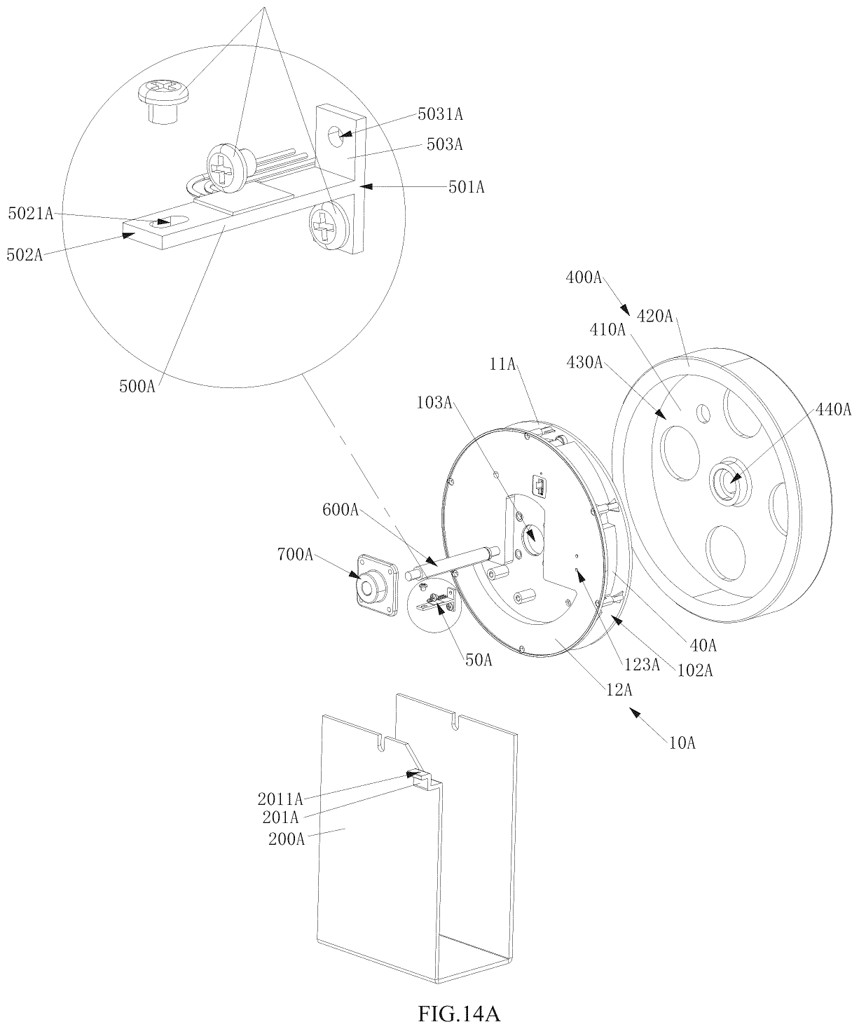

Referring to FIGS. 11 to 15B of the accompanying drawings of the present invention, a sport device 10000A accordance to another preferred embodiment of the present invention will be disclosed and illustrated in the following description, wherein the sport device 10000A comprises an internal magnetic control device 100A, an equipment frame 200A, a pedaling device 300A, a flywheel 400, and a torsion detecting device 500A.

The internal magnetic control device 100A is mounted at the equipment frame 200A, wherein the pedaling device 300A is pedalably mounted at the equipment frame 200A, wherein the flywheel 400A is rotatably mounted at the equipment frame 200A and drivably connected to the pedaling device 300A, and wherein the flywheel 400A is disposed to surround an outer side of the internal magnetic control device 100A and two opposite ends of the torsion detecting device 500A are mounted at the internal magnetic control device 100A and the equipment frame 200A, respectively. When a user continuously pedals the pedal device 300A and drives the flywheel 400A to rotate relative to the internal magnetic control device 100A and the equipment frame 200A, on the one hand, the flywheel 400A continuously cuts the magnetic induction lines of the internal magnetic control device 100A and obtains a load, so that the user can achieve the purpose of fitness by means of the sport device 10000A, on the other hand, the internal magnetic control device 100A is driven by the flywheel 400A and is subjected to torsion, and the torsion detecting device 500A is capable of detecting the torsion applied to the internal magnetic control device 100A, so that the actual power of the user when exercising through the sport device 10000A is obtained by the sport device 10000A based on the torque value fed back the torque detecting device 500A in the following time.

It is worth mentioning that the sport device 10000A, which is implemented as an elliptical machine, illustrated in the attached FIG. 11, is only exemplary and it does not limit the specific type of the sport device 10000A of the present invention. For example, in other exemplary embodiments of the present invention, the sport device 10000A may be a rowing machine, a kinetic bicycle, etc. It will be appreciated that the sport device 10000A may also be without the pedaling device 300A, which can be used to achieve fitness through the sport device 10000A as long as it allows the user to drive the flywheel 400A to rotate.

It is to be understood that the sport device 10000A has a fixed calibrated power, and that due to the assembly process of the sport device 10000A and errors in spare parts, etc., there may be a discrepancy between the actual power of the user when exercising with the sport device 10000A and the calibrated power of the sport device 10000A, and the sport device 10000A of the present invention can adjust the work state of the internal magnetic control device 100A at a later time based on the difference between the actual power of the sport device 10000A when exercising and the calibrated power of the sport device 10000A by providing a torsion detecting device 500A to detect the torque applied to the internal magnetic control device 100A when the user exercises with the sport device 10000A, so as to correct the actual power of the user when exercising through the sport device 10000A, thereby favorably improving the efficiency of the user exercising through the sport device 10000A.

It will be appreciated that the load obtained by the flywheel 400A when the flywheel 400A is driven to rotate related to the amount by which the flywheel 400A cuts the magnetic inductance line of the inner magnetron 100A. Specifically, the more the flywheel 400A cuts the magnetic inductance lines of the internal magnetic control device 100A while being driven to rotate, the greater the load that the flywheel 400A can obtain, at the same time, the user need to struggle to step on the pedaling device 300A, more greatly. Correspondingly, the less the amount of the flywheel 400A that cuts the magnetic inductance lines of the inner magnetic control device 100A while being driven to rotate, the smaller the load that the flywheel 400A is able to obtain, at which point the user uses less effort when pedaling the pedaling device 300A.

It is worth mentioning that the load obtained by the flywheel 400A when the flywheel 400A is driven to rotate is reflected in the value of the resistance of the user when stepping on the pedaling device 300A, the greater the load obtained by the flywheel 400A when it is driven to rotate, the greater the value of the resistance of the user when stepping on the pedaling device 300A, and accordingly the smaller the load obtained by the flywheel 400A when it is driven to rotate, the more effortless the user can exert when the smaller the resistance value when stepping on the pedaling device 300A.

In order to satisfy the different needs of the user for the load of the flywheel 400A of sport device 10000A and to correct the actual power of the user when exercising through the sport device 10000A to be in line with the calibrated power, the internal magnetic control device 100A of the present invention is provided to be capable of adjusting the relative position of the magnetic inductance line and the flywheel 400A, such that the closer the magnetic inductance line of the internal magnetic control device 100A is to the flywheel 400A, the more the amount of the flywheel 400A cuts the greater the amount of magnetic inductance line of the internal magnetic control device 100A while being driven to rotate by the internal magnetic control device 100A, and accordingly, the further away from the flywheel 400A the magnetic inductance line of the internal magnetic control device 100A is positioned, the less the amount of magnetic inductance line which the flywheel 400A cuts while being driven to rotate. Thus, on the one hand, the value of the resistance of the user when pedaling on the pedaling device 300A can be adjusted, and on the other hand, the actual power and the calibrated power of the user when he or she is exercising by means of the sport device 10000A can be corrected to be the same, by adjusting the relative positions of the magnetic inductance lines of the inner magnetic control device 100A and the flywheel 400A.

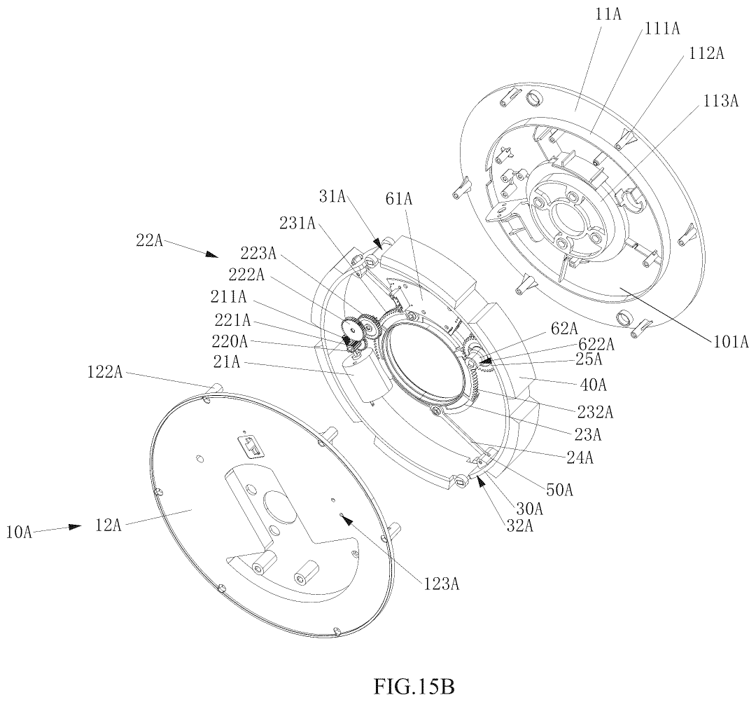

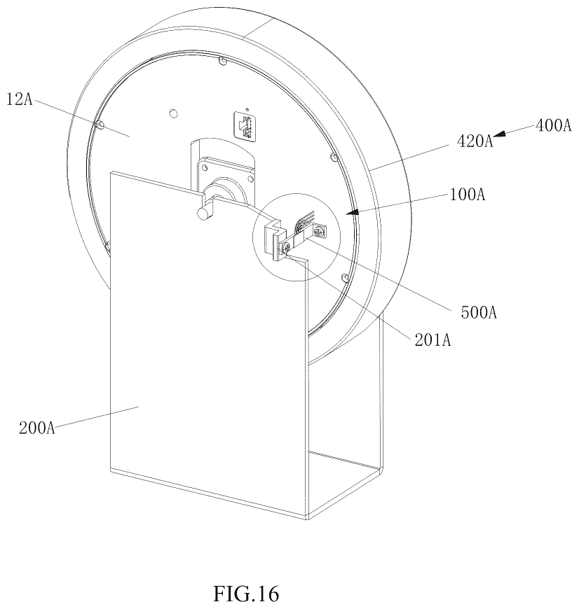

Specifically, with reference to FIGS. 15A and 15B of the accompanying drawings, the internal magnetic control device 100A comprises a magnetic control housing 10A, a driving unit 20A, at least one swing arm 30A, and at least one magnetic element 40A. The magnetic control housing 10A has a housing space 101A and a periphery opening communicated with the housing space 101A. The driving unit 20A is provided in the housing space 101A of the magnetic control housing 10A to provide a driving force. The swing arm 30A has a pivot end 31A and a driven end 32A corresponded to the pivot end 31A, wherein the pivot end 31A of the swing arm 30A is pivotally mounted at the magnetic control housing 10A, the driven end 32A of the swing arm 30A is drivably connected to the driving unit 20A to allow the driving unit 20A to drive the swing arm 30A to swing in the periphery opening 102A of the magnetic control housing 10A. The magnetic clement 40A is provided at the swing arm 30A to allow the magnetic clement 40A to provide a magnetic field environment at the perimeter opening 102A of the magnetron housing 10A. The flywheel 400A surrounds the outer side of the magnetic control housing 10A of the internal magnetic control device 100A and the periphery opening 102A of the magnetic control housing 10A is corresponded to the inner side of the flywheel 20 such that when the flywheel 400A is driven to rotate relative to the internal magnetic control device 100A the flywheel 400A is capable of cutting the magnetic field of the magnetic clement 40A of the internal magnetic control device 100A to obtain a load.

It is worth mentioning that the number of the swing arms 30A of the internal magnetic control device 100A is not limited in the sport device 10000A of the present invention, for example, in this specific example illustrated in the accompanying FIGS. 15A and 15B, the internal magnetic control device 100A comprises two swing arms 30A, the two swing arms 30A are held in the periphery opening 102A of the magnetic control housing 10A in a centrosymmetric manner, wherein each of the swing arms 30A are respectively provided with the magnetic element 40A. Optionally, in other specific examples of the sport device 10000A of the present invention, the internal magnetic control device 100A comprises three swing arms 30A, wherein the three swing arms 30A are held in the periphery opening 102A of the magnetic control housing 10A in a centrosymmetric manner, wherein each of the swing arms 30A is respectively provided with the magnetic clement 40A.

Preferably, an outer side of each swing arm 30A faces the periphery opening 102A of the magnetic control housing 10A, and the magnetic clement 40A are provided at an outer side of the swing arm 30A, so that the magnetic element 40A can be directly exposed to the periphery opening 102A of the magnetic control housing 10A.

It is worth mentioning that the manner in which the magnetic clement 40A is provided at the swing arm 30A is not limited in the sport device 10000A of the present invention. For example, in a preferred example of the sport device 10000A of the present invention, the magnetic element 40A may be provided at the swing arm 30A by gluing. Alternatively, in other examples of the flywheel assembly 10000A of the present invention, the magnetic element 40A may be provided at the swing arm 30A by being embedded.

It is worth mentioning that the number of the magnetic elements 40A provided in the swing arm 30A is not limited in the sport device 10000A of the present invention. For example, in this specific example illustrated in the accompanying FIGS. 15A and 15B, the three magnetic elements 40A are provided at the swing arm 30A spaced apart from each other, i.e., each two adjacent magnetic elements 40A has a gap therebetween.

Preferably, the swing arm 30A is curved between the pivoting end 31A and the driven end 32A such that swing arm 30A has an arc shape, so an outer side of the swing arm 30A has a shape the same as the shape of the periphery of the magnetic control housing 10A, substantially. Preferably, the magnetic elements 40A are curved and an inner side of the magnetic element 40A has a shape the same as the shape of the outer side of the swing arm 30A, so as to facilitate reliable setting of the magnetic elements 40A on the outer side of the swing arm 30A.

With continued reference to FIGS. 15A and 15B, the magnetic control housing 10A further comprises a disk-shaped first housing 11A and a disk-shaped second housing 12A, wherein the first housing 11A has a first ring 111A and the second housing 12A has a second ring 121A, wherein the first housing 11A and the second housing 12A are mounted with each other in such a manner the first ring 111A and the second ring 121A are corresponded to each other, so that the housing space 101A is defined between an inner side of the first ring 111A and an inner side of the second ring 121A, the periphery opening 102A is defined at an outer side of the first ring 111A and an outer side of the second ring 121A. Preferably, both of the first shell 11A and the second shell 12A are made of plastic material.

Further, a plurality of first mounting pillars 112A are provided at an edge of the first housing 11A, a plurality of second mounting pillars 122A are provided on an edge of the second housing 12A, and each of the first mounting pillars 112A of the first housing 11A and each of the second mounting pillars 122A of the second housing 12A, respectively, are mounted and supported against each other to avoid deformation of the edge of the first housing 11A and the edge of the second housing 12A. Preferably, screws are permitted to be mounted to the first mounting pillars 112A of the first housing 11A and the second mounting pillars 122A of the second housing 12A to lock the first housing 11A and the second housing 12A at the edge of the first housing 11A and the edge of the second housing 12A.

Two opposite sides of the pivot end 31A of the swing arm 30A are pivotally mounted at an edge of the first housing 11A and an edge of the second housing 12A, respectively, to pivotally mount the pivot end 31A of the swing arm 30A at an edge of the magnetic control housing 10A, and the swing arm 30A is allowed to swing in the periphery opening of the magnetic control housing 10A 102A. The first mounting pillars 112A of the first housing 11A and the second mounting pillars 122A of the second housing 12A are disposed at an outside of the swing arm 30A to limit the magnitude of outward swing of the swing arm 30A. Preferably, the first mounting pillars 112A of the first housing 11A and the second mounting pillars 122A of the second housing 12A is corresponded to gaps defined between each two adjacent magnetic elements 40A to avoid the magnetic clement 40A such that the swing arm 30A is able to drive the magnetic element 40A to have a greater swing

The magnetic control housing 10A has a center through hole 103A, the housing space 101A is disposed to surround the center through hole 103A and the housing space 101A is separated from the center through hole 103A, wherein a mounting shaft 600A may be mounted through the center through hole 103A of the magnetic control housing 10A by a flange 700A.

Further, the flywheel 400A comprises a wheel disk 410A and a wheel ring 420A and has a wheel cavity 430A and a flywheel through hole 440A communicated with the wheel cavity 430A, the wheel ring 420A is integrally extended at an edge of the wheel disk 410A to form the wheel cavity 430A between the wheel ring 420A and the wheel disk 410A, the flywheel through hole 440A is formed in a center of the wheel ring 420A. The inner magnetic control device 100A is mounted in the wheel cavity 430A of the flywheel 400A and the wheel ring 420A surrounds an outside of the periphery opening 102A of the magnetic control housing 10A of the inner magnetic control device 100A, the flywheel through hole 440A of the flywheel 400A is corresponded to the center through hole 103A of the magnetic control housing 10A of the inner magnetic control device 100A, wherein the mounting shaft 600A is threaded into the flywheel through hole 440 of the flywheel 400A, so that the flywheel 400A and the internal magnetic control device 100A are assembled and allowing the flywheel 400A to rotate relative to the internal magnetic control device 100A. Alternatively, the mounting shaft 600A may be used to mount the internal magnetic control device 100A and the flywheel 400A at the equipment frame 200A, and the mounting shaft 600A allows a relative position between the internal magnetic control device 100A and the equipment frame 200A to be maintained and the flywheel 400A to rotate relative to the equipment frame 200A.

When the driving unit 20A drives the swing arm 30A to swing relative to the magnetic control housing 10A, the swing arm 30A is capable of driving the magnetic element 40A to swing synchronously in the same amplitude in order to change a relative position of the magnetic element 40A and the flywheel 400A, thereby adjusting a relative position of the magnetic inductance lines of the internal magnetic control device 100A and the flywheel 400A, so as to adjust the load obtained by the flywheel 400A when it is driven to rotate and achieve the purpose of controlling the value of the resistance of the sport device 10000A.

Specifically, when the driving unit 20A drives the swing arm 30A to swing outwardly to a maximum swinging position, the relative distance between the magnetic clement 40A and the flywheel 400A is adjusted to a minimum design value, at this point, the magnetic inductance lines cut through by the flywheel 400A has a maximum value, i.e., the resistance obtained by the user when rotating the flywheel 400A is a maximum resistance, i.e., the resistance obtained by the user when driving the flywheel 400A to rotate is the maximum resistance. Correspondingly, when the driving unit 20A drives the swing arm 30A to swing inwardly to a minimum swing position, the relative distance between the magnetic clement 40A and the flywheel 400A is adjusted to a maximum design value, at this point, the magnetic inductance lines cut through by the flywheel 400A has a minimum value, i.e., the resistance obtained by the flywheel 400A is a minimum resistance, i.e., the resistance obtained by the user when driving the flywheel 400A to rotate is the minimum resistance.

It is understood that in the course of the drive unit 20A driving the swing arms 30A to swing from the minimum swinging position to the maximum swinging position, the amount of the magnetic inductance lines of the magnetic elements 40A cut by the flywheel 400A while being driven to rotate is gradually increased, so that the resistance obtained by the flywheel 400A while being driven to rotate is gradually increased. Correspondingly, in the course of the drive unit 20A driving the swing arms 30A to swing from the maximum swing position to the minimum swing position, the amount of the flywheel 400A that cuts the magnetic inductance lines of the magnetic elements 40A while being driven to rotate gradually decreases, so that the resistance obtained by the flywheel 400A while being driven to rotate gradually decreases.

With continued reference to FIGS. 15A and 15B, the driving unit 20A of the inner magnetic control device 100A further comprises a driving motor 21A, a transmission gear set 22A, a driving ring 23A and at least one linkage member arm 24A. The driving motor 21A is mounted at the first housing 11A and/or the second housing 12A of the magnetic control housing 10A, and the driving motor 21A is held within the housing space 101A of the magnetic control housing 10A. Two opposite sides of the transmission gear set 22A are rotatably mounted at the first housing 11A and the second housing 12A of the magnetic control housing 10A, respectively, such that the transmission gear set 22A is rotatably held in the housing space 101A of the magnetic control housing 10A, and one gear of the transmission gear set 22A is engaged with a worm gear 211A of the driving motor 21A. The driving ring 23A is rotatably mounted at the first housing 11A and/or the second housing 12A of the magnetic control housing 10A such that the driving ring 23A is rotatably held in the housing space 101A of the magnetic control housing 10A, wherein the driving ring 23A has a plurality of first ring teeth 231A and another gear of the transmission gear set 22A is engaged with the first ring teeth 231A of the driving ring 23A, such that power provided by the driving motor 21A can be transmitted to the driving ring 23A by the transmission gear set 22A to drive the driving ring 23A to rotate within the housing space 101A of the magnetic control housing 10A. One end of the linkage member arm 24A is rotatably mounted at the driving ring 23A and another end of the linkage member arm 24A is rotatably mounted to the driven end 32A of the swing arm 30A. When the driving motor 21A drives the driving ring 23A to rotate through the transmission gear set 22A, the driving ring 23A drives the swing arm 30A to swing through the linkage member arm 30A, so as to adjust a relative position between the magnetic element 40A and the flywheel 400A.

Specifically, referring to FIGS. 15A and 15B, when the driving motor 21A drives the driving ring 23A to rotate clockwise through the transmission gear set 22A, the driving ring 23A drives the swing arm 30A to swing inwardly through the linkage member arm 24A to allow the swing arm 30A to swing from the maximum swing position to the minimum swing position. Correspondingly, when the driving motor 21A drives the driving ring 23A to rotate counterclockwise through the transmission gear set 22A, the driving ring 23A drives the swing arm 30A to swing outwardly through the linkage member arm 24A to allow the swing arm 30A to swing from the minimum swing position to the maximum swing position.

It is worth mentioning that the number of the linkage member arms 24A of the driving unit 20A is corresponded to the number of the swing arms 30A. For example, in this specific example of the sport device 10000A of the present invention illustrated in FIGS. 15A and 15B, the internal magnetic control device 100A comprises two swing arms 30A, and accordingly, the driving unit 20A comprises two linkage member arms 24A, wherein each of the two linkage member arms 24A has a first end and a second end, wherein the first ends of the two linkage member arms 24A are pivotally and respectively mounted at two opposite sides of the driving ring 23A, the second ends of the two linkage member arms 24A are pivotally and respectively mounted at the driven ends 32A of the two swing arm 30A, so that when the driving motor 21A drives the driving ring 23A to rotate by the transmission gear set 22A, the driving ring 23A is capable of driving each of the swing arm 30A to swing by each of the linkage member arm 24A, respectively. It will be appreciated that in the embodiment where the number of the swing arms 30A of the internal magnetic control device 100A is three, the number of the linkage member arms 24A of the driving unit 20A is selected to be three.

It is worth mentioning that the number of gears in the transmission gear set 22A is not limited in the sport device 10000A of the present invention, for example, in this specific example of the sport device 10000A illustrated in FIGS. 15A and 15B, the number of the gears of the transmission gear set 22A is three, which are defined as a first gear 221A, a third gear 223A, and a second gear 222A which is engaged in the first gear 221A and the third gear 223A, respectively, wherein the first gear 221A, the second gear 222A, and the third gear 223A are rotatably and respectively held within the housing space 101A of the magnetic control housing 10A, for example, each of the first gear 221A, the second gear 222A and the third gear 223A have a rotation axis 220A, and two opposite ends of each of the rotation axes 220A of the first gear 221A, the second gear 222A and the third gear 223A are rotatably mounted in the first housing 11A and the second housing 12A of the magnetic control housing 10A, respectively, such that the first gear 221A, the second gear 222A and the third gear 223A are rotatably and respectively held in the housing space 101A of the magnetic control housing 10A. The first gear 221A is engaged with the worm gear 211A of the driving motor 21A and the third gear 223A is engaged with the first ring tooth 231A of the driving ring 23A, so that the power supplied by the driving motor 21A is able to be transmitted to the driving ring 23A by the first gear 221A, the second gear 222A and the third gear 223A one at a time, and that the power supplied by the driving motor 21A is able to be transmitted through the driving ring 23A at one time, so as to drive the swing arm 30A to swing by the driving ring 23A via the linkage member arm 24A.

It is worth noting that the manner in which the linkage member arm 24A and the driven end 32A of the swing arm 30A are mounted is not limited in the exercise apparatus 10000A of the present invention. For example, in this specific example of the sport device 10000A illustrated FIGS. 15A and 15B, the internal magnetic control device 100A further comprises at least one assembling body 50A, the assembling body 50A is mounted at the driven end 32A of the swing arm 30A, and one end of the linkage member arm 24A is rotatably mounted at the assembling body 50A.

With continued reference to FIGS. 15A and 15B, in this specific example of the exercise apparatus 10000A of the present invention, the driving motor 21A of the driving unit 20A is fixedly mounted at the first housing 11A of the magnetic control housing 10A. The first housing 11A has a convex plate 113A, wherein the driving ring 23A is rotatably sleeved on the convex plate 113A of the first housing 11A, such that when the driving ring 23A is driven, the driving ring 23A is capable of rotating around a central axis. In other words, the driving ring 23A is capable of rotating around the mounting shaft 600A when being driven, so as to adjust the relative position between the magnetic element 40A and the flywheel 400A.

With continued reference to FIGS. 15A and 15B, the driving unit 20A further comprises an auxiliary gear 25A, wherein the auxiliary gear 25A is rotatably mounted in within the housing space 101A of the magnetic control housing 10A, wherein the driving ring 23A has a plurality of second ring teeth 232A, wherein the second ring teeth 232A of the driving ring 23A and the auxiliary gear 25A are engaged with each other to avoid tilting of the driving ring 23A when the driving ring 23A is driven, thereby ensuring that the driving ring 23A steadily and reliably rotates around the central axis relative to the magnetic control housing 10A.

With continued reference to FIGS. 15A and 15B, the internal magnetic control device 100A further includes a potential control unit 60A, wherein the potential control unit 60A includes a circuit board 61A, wherein the circuit board 61A is provided in the housing space 101A of the magnetic control housing 10A, the driving motor 21A of the driving unit 20A is connected to the circuit board 61A of the potential control unit 60A. Preferably, the circuit board 61A is fixedly mounted to the first housing 11A of the magnetic control housing 10A, e.g. the circuit board 61A may be fixedly mounted to the first housing 11A of the magnetic control housing 10A by, but not limited to, screws.

The potential control unit 60A further comprises a rotary potentiometer 62A, wherein the rotary potentiometer 62A is provided at the circuit board 61A, and the rotary potentiometer 62A has a mounting end 621A and a rotating shaft 622A, wherein the mounting end 621A of the rotary potentiometer 62A is mounted to the first housing 11A, the auxiliary gear 25A is mounted to the rotating shaft 622A of the rotary potentiometer 62A, so the auxiliary gear 25A is rotatably mounted within the housing space 101A of the magnetic control housing 10A. When the driving motor 21A drives each of the swing arms 30A to swing inwardly or outwardly through each of the linkage member arms 22A by rotating the driving ring 23A, the driving ring 23A synchronously drives the auxiliary gear 25A to rotate, and at the same time, the auxiliary gear 25A drives the rotating shaft 622A of the rotary potentiometer 62A to rotate and change the resistance value of the rotary potentiometer 62A. It will be appreciated that the resistance value of the rotary potentiometer 62A is related to the rotation position of the driving ring 23A, which determines the swinging position of the swing arm 30A and the position of the magnetic element 40A, which in turn determines the load of the flywheel 20B while being driven to rotate. In other words, the position of the magnetic clement 40A of the internal magnetic control device 100A of the sport device of the present invention and the load of the flywheel 400A while being driven to rotate can be determined by detecting the resistance value of the rotary potentiometer 62A.

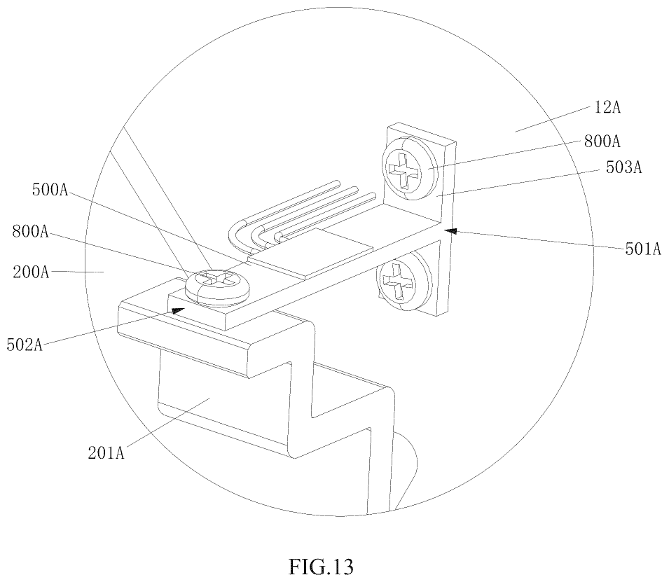

With continued reference to FIGS. 12 to 14B, the torque detecting device 500A has a device mounting end 501A and a frame mounting end 502A corresponded to the device mounting end 501A, wherein the device mounting end 501A of the torque detecting device 500A is mounted to the magnetic control housing 10A of the inner magnetic control device 100A, the frame mounting end 502A of the torque detecting device 500A is mounted to the equipment frame 200A and an extension direction of the torque detecting device 500A and an extension direction of the internal magnetic control device 100A are perpendicular to each other, so that, on the one hand, the torque detecting device 500A is capable of detecting the torque applied to the internal magnetic control device 100A, so that the exercise device 10000A can obtain the actual power of the user exercising through the exercise device 10000A based on the torque value fed back by the torque detecting device 500A, and on the other hand, the torque detecting device 500A can avoid the problem of deformation of the magnetic control housing 10A caused by the equipment frame 200A pulling on the magnetic control housing 10A of the inner magnetic control device 100A by the torque detecting device 500A, so as to ensure that the internal magnetic control device 100A is always kept in a natural mounted state, which is of vital importance to ensure the reliability and stability of the inner magnetic control device 100A.

Referring to FIGS. 15A and 15B of the accompanying drawings of the present invention, the driving motor 21A, the transmission gear set 22A, the driving ring 23A and the auxiliary gear 25A of the driving unit 20A are mounted at the first housing 11A and/or the second housing 12A made of plastic material, and it is to be understood that once the first housing 11A and/or the second housing 12A are deformed, which will inevitably lead to a poor meshing of the worm gear 211A, the transmission gear set 22A, the driving ring 23A and the auxiliary gear 25A of the driving motor 21A and result in problems of increased noise, reduced life and transmission failure. In order to avoid the problem of deformation of the first housing 11A and/or the second housing 12A while the sport device 10000A is being used, the extension direction of the torque detecting device 500A of the present invention is provided to be perpendicular to the extension direction of the internal magnetic control device 100A.

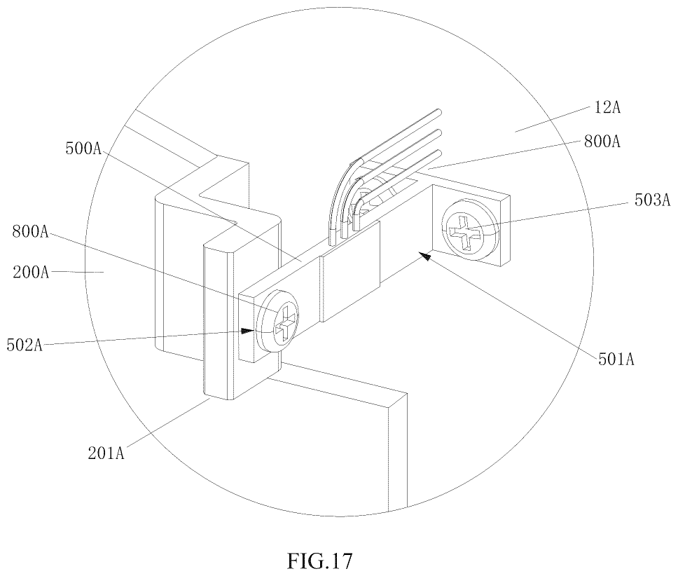

Preferably, in this specific example of the sport device 10000A illustrated in FIGS. 11 to 15B, the torque detecting device 500A is parallel to a horizontal plane. Optionally, in this optional example of the sport device 10000A illustrated in FIGS. 16 and 17, the torque detecting device 500A is perpendicular to a horizontal plane. Optionally, in other examples of the sport device 10000A, the torque detecting device 500A and the horizontal plane may have an angle.

It is worth mentioning that the manner in which the device mounting end 501A of the torque detecting device 500A is mounted to the magnetic control housing 10A of the inner magnetic control device 100A is not limited in the sport device 10000A of the present invention. For example, with reference to FIGS. 12 to 14A, the device mounting end 501A of the torque detecting device 500A has at least one mounting arm 503A, wherein the mounting arm 503A has a first mounting hole 5031A, and the second housing 12A of the magnetic control housing 10A has at least one first assembling hole 123A, wherein at least one screw 800A is able to pass through the first mounting hole 5031A of the mounting arm 503A of the torque detecting device 500A and be screwed in an inner wall of the second housing 12A, which is used for forming the first assembling hole 123A, so as to mount the device mounting end 501A of the torque detecting device 500A to the second housing 12A of the magnetic control housing 10A by the screw 800A. Preferably, the device mounting end 501A of the torque detecting device 500A has two mounting arms 503A, each of the mounting arm 503A has one first mounting hole 5031A, respectively, and accordingly the second housing 12A has two first assembling holes 123A, wherein two screws 800A are capable of passing through the first mounting holes 5031A of the mounting arms 503A of the torsion detection device 500A, respectively, and being screwed to the inner wall of the second housing 12A for forming the first assembling holes 123A, so as to mount the device mounting end 501A of the torque detecting device 500A at the second housing 12A of the magnetic control housing 10A by the two screws 800A.

It is worth mentioning that the manner in which the frame mounting end 502A of the torsion detecting device 500A is mounted to the equipment frame 200A is not limited in the sport device 10000A of the present invention. For example, with reference to FIGS. 12 to 14A, the frame mounting end 502A of the torque detecting device 500A has a second mounting hole 5021A, the equipment frame 200A has an assembling platform 201A, wherein the assembling platform 201A is extended outwardly and upwardly, and the assembling platform 201A has a second assembling hole 2011A, wherein the screw 800A is able to pass through the second mounting hole 5021A of the torque detecting device 500A and be screwed to the inner wall of the assembling platform 201A of the equipment frame 200A to mount the frame mounting end 502A of the torque detecting device 500A to the equipment frame 200A by the screw 800A, which is used for forming the second assembling hole 2011A, and the torque detecting device 500A is held suspended between the equipment frame 200A and the internal magnetic control device 100A by the assembling platform 201A such that the torque detecting device 500A is capable of detecting the torque applied to the internal magnetic control device 100A. Optionally, in this optional example of the sport device 10000A illustrated in FIGS. 16 and 17, the assembling platform 201A of the equipment frame 200A is extended outwardly and laterally.

Preferably, at least one of the mounting position of the device mounting end 501A of the torque detecting device 500A and the inner magnetic control device 100A and the mounting position of the frame mounting end 502A of the torque detecting device 500A and the equipment frame 200A can be adjusted, so the torque detecting device 500A is mounted between the equipment frame 200A and the inner magnetic control device 100A, which can make the problem of deformation of the magnetic control housing 10A of the inner magnetic control device 100A caused by the equipment frame 200A pulling on the inner magnetic control device 100A by the torque detecting device 500A be avoided.

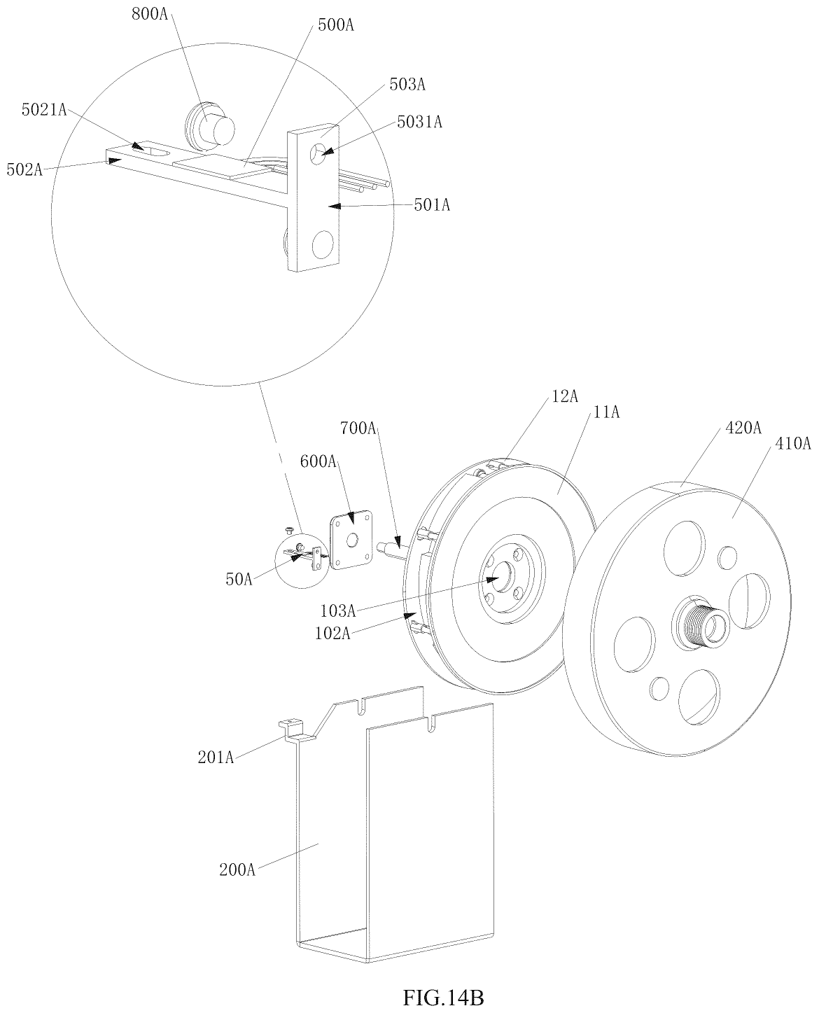

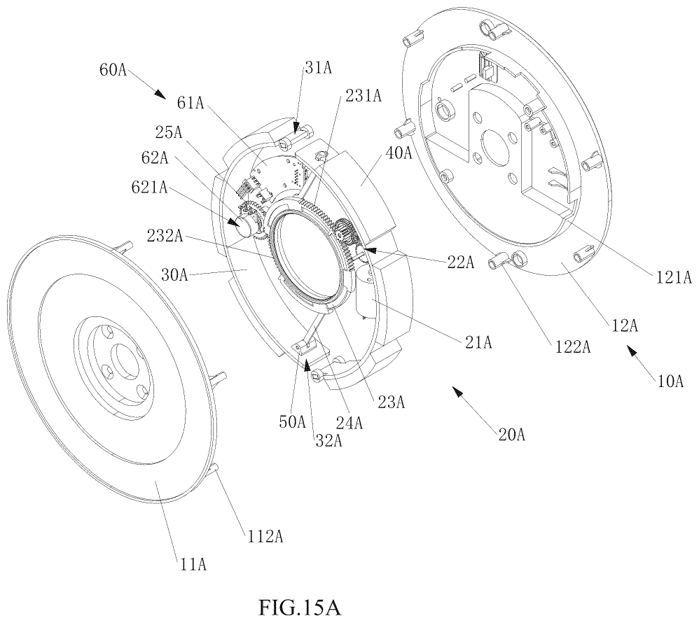

Specifically, with reference to FIGS. 14A and 14B, the second mounting hole 5021A of the frame mounting end 502A of the torque detecting device 500A has a length dimension greater than the screw 800A, e.g., the second mounting hole 5021A may be an elongated mounting hole, such that the mounting position of the frame mounting end 502A of the torque detecting device 500A and the equipment frame 200A can be adjusted. It will be understood by those skilled in the art that the above embodiments are only examples, wherein features of different embodiments may be combined with each other to obtain embodiments that are readily conceivable in light of the disclosure of the present invention but are not explicitly indicated in the accompanying drawings.

Those skilled in the art should understand that the embodiments of the present invention shown in the above description and the accompanying drawings are only examples and do not limit the present invention. The objects of the present invention have been completely and effectively realized. The function and structural principle of the present invention have been shown and explained in the above embodiments. Without departing from the principle, the embodiments of the present invention can be deformed or modified.

1-59. (canceled)

60. A sport device, comprising:
an equipment body;
a rotating wheel defining a magnetic conductive surface and a receiving space, wherein the resistance adjusting device is held within the receiving space of the rotating wheel, wherein the rotating wheel is capable of being driven to rotate relative to the resistance adjusting device;
a resistance adjusting device comprising a first magnetic tile, a second magnetic tile, a rotating member and a base plate, wherein each of the first magnetic tile and the second magnetic tile has a magnetic surface, wherein the rotating member is rotatably mounted at the base plate, the first magnetic tile and the second magnetic tile are movably and spacedly held at two outer sides of the rotating member;
a metal spacer held between the magnetic conductive surface of the rotating wheel and the magnetic surfaces of the first magnetic tile and the second magnetic tile, wherein the magnetic conductive surface is corresponded to the magnetic surfaces;
a first linkage member; and
a second linkage member, wherein two ends of the first linkage member are pivotally and respectively connected with the rotating member and the first magnetic tile, and two ends of the second linkage member are pivotally and respectively connected with the rotating member and the second magnetic tile such that when the rotating member is driven to rotate clockwise with respect to the base plate, the rotating member is capable of driving the first linkage member and the second linkage member to move and enable the first linkage member and the second linkage member to pull the first magnetic tile and the second magnetic tile to moves in a direction far away from the magnetic conducting surface of the rotating wheel respectively; when the rotating member is driven to rotate counterclockwise with respect to the base plate, the rotating member is capable of driving the first linkage member and the second linkage member to move and enable the first linkage member and the second linkage member to push the first magnetic tile and the second magnetic tile to moves in a direction closer to the magnetic conducting surface of the rotating wheel respectively, wherein the rotating wheel of the resistance-adjustable rotating wheel is drivably connected with the equipment body.

61. The sport device, as recited in claim 60, wherein the first linkage member and the second linkage member are centrosymmetric.

62. The sport device, as recited in claim 60, wherein the first linkage member has an extension direction parallel to an extension direction of the second linkage member.

63. The sport device, as recited in claim 60, wherein the first linkage member is inclinedly held between the first magnetic tile and the rotating member, and the second linkage member is inclinedly held between the second magnetic tile and the rotating member.

64. The sport device, as recited in claim 63, wherein the first linkage member and the first magnetic tile has an angle of inclination no less than 90°, the second linkage member and the second magnetic tile has an angle of inclination no less than 90°.

65. The sport device, as recited in claim 63, wherein the first linkage member and the second linkage member are parallel to each other.

66. The sport device, as recited in claim 60, wherein the first magnetic tile comprises a first load-bearing element and at least one first magnetic block, the second magnetic tile comprises a second load-bearing element and at least one second magnetic block, wherein the magnetic surfaces are formed by the at least one first magnetic block and the at least one second magnetic block, wherein the at least one first magnetic block and the at least one second magnetic block generate a magnetic field between the magnetic conductive surface and the at least one first magnetic block and the at least one second magnetic block.

67. The sport device, as recited in claim 60, wherein the resistance adjusting device further comprises a driving motor and a transmission gear set, wherein the driving motor and the transmission gear set are mounted at the base plate, wherein the driving motor and the transmission gear set are provided to drive the rotating member to rotate.

68. The sport device, as recited in claim 60, wherein the magnetic conductive surface of the rotating wheel defined by metal material.

69. The sport device, as recited in claim 60, wherein further comprising a torque detecting device comprising a connecting member and a torque sensing member, wherein the connecting member comprises a strain portion, a fixed end and a assembling end extended integrally from two sides of the strain portion, wherein the torque sensing member is provided at the strain portion, the fixed end of the connecting member is adapted to be fixedly mounted at a fixing device, the assembling end is fixedly provided at resistance adjusting device such that the torque detecting device is capable of detecting a torque to which the resistance adjusting device is subjected, when the rotating wheel rotates relative to the resistance adjusting device.

70. A resistance-adjustable rotating wheel for a sport device, comprising:
a rotating wheel defining a magnetic conductive surface and a receiving space, wherein the resistance adjusting device is held within the receiving space of the rotating wheel, wherein the rotating wheel is capable of being driven to rotate relative to the resistance adjusting device;
a resistance adjusting device comprising a first magnetic tile, a second magnetic tile, a rotating member and a base plate, wherein each of the first magnetic tile and the second magnetic tile has a magnetic surface, wherein the rotating member is rotatably mounted at the base plate, the first magnetic tile and the second magnetic tile are movably and spacedly held at two outer sides of the rotating member;
a metal spacer held between the magnetic conductive surface of the rotating wheel and the magnetic surfaces of the first magnetic tile and the second magnetic tile, wherein the magnetic conductive surface is corresponded to the magnetic surfaces;
a first linkage member; and
a second linkage member, wherein two ends of the first linkage member are pivotally and respectively connected with the rotating member and the first magnetic tile, and two ends of the second linkage member are pivotally and respectively connected with the rotating member and the second magnetic tile such that when the rotating member is driven to rotate clockwise with respect to the base plate, the rotating member is capable of driving the first linkage member and the second linkage member to move and enable the first linkage member and the second linkage member to pull the first magnetic tile and the second magnetic tile to moves in a direction far away from the magnetic conducting surface of the rotating wheel respectively; when the rotating member is driven to rotate counterclockwise with respect to the base plate, the rotating member is capable of driving the first linkage member and the second linkage member to move and enable the first linkage member and the second linkage member to push the first magnetic tile and the second magnetic tile to moves in a direction closer to the magnetic conducting surface of the rotating wheel respectively.

71. The resistance-adjustable rotating wheel for a sport device, as recited in claim 70, wherein the first linkage member and the second linkage member are centrosymmetric.

72. The resistance-adjustable rotating wheel for a sport device, as recited in claim 70, wherein the first linkage member has an extension direction parallel to an extension direction of the second linkage member.

73. The resistance-adjustable rotating wheel for a sport device, as recited in claim 70, wherein the first linkage member is inclinedly held between the first magnetic tile and the rotating member, and the second linkage member is inclinedly held between the second magnetic tile and the rotating member.

74. The resistance-adjustable rotating wheel for a sport device, as recited in claim 73, wherein the first linkage member and the first magnetic tile has an angle of inclination no less than 90°, the second linkage member and the second magnetic tile has an angle of inclination no less than 90°.

75. The resistance-adjustable rotating wheel for a sport device, as recited in claim 73, wherein the first linkage member and the second linkage member are parallel to each other.

76. The resistance-adjustable rotating wheel for a sport device, as recited in claim 70, wherein the first magnetic tile comprises a first load-bearing element and at least one first magnetic block, the second magnetic tile comprises a second load-bearing element and at least one second magnetic block, wherein the magnetic surfaces are formed by the at least one first magnetic block and the at least one second magnetic block, wherein the at least one first magnetic block and the at least one second magnetic block generate a magnetic field between the magnetic conductive surface and the at least one first magnetic block and the at least one second magnetic block.

77. The resistance-adjustable rotating wheel for a sport device, as recited in claim 70, wherein the resistance adjusting device further comprises a driving motor and a transmission gear set, wherein the driving motor and the transmission gear set are mounted at the base plate, wherein the driving motor and the transmission gear set are provided to drive the rotating member to rotate.

78. The resistance-adjustable rotating wheel for a sport device, as recited in claim 70, wherein the magnetic conductive surface of the rotating wheel defined by metal material.

79. The resistance-adjustable rotating wheel for a sport device, as recited in claim 70, wherein further comprising a torque detecting device comprising a connecting member and a torque sensing member, wherein the connecting member comprises a strain portion, a fixed end and a assembling end extended integrally from two sides of the strain portion, wherein the torque sensing member is provided at the strain portion, the fixed end of the connecting member is adapted to be fixedly mounted at a fixing device, the assembling end is fixedly provided at resistance adjusting device such that the torque detecting device is capable of detecting a torque to which the resistance adjusting device is subjected, when the rotating wheel rotates relative to the resistance adjusting device.
